(19) United States
(12) Patent Application Publication
(10) Pub. No.: US 2026/0290905 A1
(43) Pub. Date: Sep. 24, 2026

(54) BATTERY STACK UNIT

(71) Applicant: QUANTUMSCAPE BATTERY, INC., San Jose, CA (US)

(72) Inventors: Cheng-Chieh CHAO, San Jose, CA (US); Sriram IYER, San Jose, CA (US); Mohit SINGH, San Jose, CA (US); Martin WINTERKORN, San Jose, CA (US); Timothy HOLME, San Jose, CA (US)

(21) Appl. No.: 19/686,538

(22) Filed: May 22, 2026

Related U.S. Application Data
(63) Continuation of application No. PCT/US2024/058535, filed on Dec. 4, 2024.
(60) Provisional application No. 63/606,444, filed on Dec. 5, 2023.

(51) Int. Cl. H01M 10/0585; H01M 10/052; H01M 10/0562; H01M 50/474; H01M 50/483

(52) U.S. Cl. CPC H01M 10/0585; H01M 10/052; H01M 10/0562; H01M 50/474; H01M 50/483

(57) ABSTRACT

Provided herein are embodiments related to a bilayer stack comprising a positive electrode current collector (PECC); a first negative electrode current collector (NECC) and a second NECC; a first metal layer and a second metal layer; a first cathode and a second cathode on opposite sides of, and in contact with, the PECC. Provided herein are also batteries which include two or more bilayer stacks. The bilayer stack further comprises a first solid-state electrolyte between the first metal layer and the first cathode; and a second solid-state electrolyte adjacent to the second cathode.

### CROSS-REFERENCE TO RELATED APPLICATIONS

The present application is a continuation application of International Patent Application No. PCT/US2024/058535 that claims priority to, and the benefit of, U.S. Provisional Patent Application No. 63/606,444, filed Dec. 5, 2023, the entire contents of which are herein incorporated by reference in its entirety for all purposes.

### FIELD

The present application relates to solid-state lithium batteries.

### BACKGROUND

Cleaner forms of storing energy are in great demand. Examples of clean energy storage include rechargeable lithium (Li) ion batteries (i.e., Li-secondary batteries). In numerous applications (e.g., portable electronics and transportation), it is advantageous to use a solid-state Li metal battery due to safety, as well as energy density considerations. Solid-state Li metal batteries that incorporate a Li-metal negative electrode also have the advantage of significantly lower electrode volumes, and correspondingly, increased energy densities.

Set forth herein are solid-state Li metal batteries.

### SUMMARY

In an aspect, a bilayer stack comprises a first negative electrode current collector (NECC); a first metal layer; a first solid-state electrolyte; a first cathode; a positive electrode current collector (PECC); a second cathode; a second solid-state electrolyte; a second metal layer; and a second NECC; wherein the first cathode and the second cathode are on opposite sides of, and in contact with, the PECC; wherein the first NECC is adjacent to the first metal layer; and wherein the second NECC is adjacent to the second metal layer.

In some further embodiments, the first solid-state electrolyte and the second solid-state electrolyte each, individually in each instance, comprise lithium-stuffed garnet.

In certain further embodiments, the first solid-state electrolyte and the second solid-state electrolyte each, individually in each instance, is a film.

In various further embodiments, the first solid-state electrolyte has a thickness in the range of 1 μm-100 μm, and the second solid-state electrolyte has a thickness in the range of 1 μm-100 μm. For example, the thickness of the first and/or second solid-state electrolyte is at least 10 nm, 50 nm, 5 μm, 10 μm, 15 μm, 20 μm, and 25 μm, or range from 1 μm-20 μm, 10 μm-20 μm, 20 μm-50 μm, 30 μm-60 μm, 25 μm-75 μm, 20 μm-80 μm, and 15 μm-30 μm.

In some further embodiments, the metal layer comprises nickel (Ni), iron (Fe), copper (Cu), platinum (Pt), gold (Au), silver (Ag), an alloy thereof, or a combination thereof.

In some further embodiments, the first solid-state electrolyte is in between the first metal layer and the first cathode. In some embodiments, the second solid-state electrolyte is in between the second metal layer and the second cathode.

In various further embodiments, the bilayer stack further comprises a first lithium metal layer between, and in contact with, the first solid-state electrolyte and the first metal layer. In some further embodiments, the bilayer stack further comprises a second lithium metal layer between, and in contact with, the second solid-state electrolyte and the second metal layer.

In some further embodiments, the first cathode, the second cathode, or both, may each, individually in each instance, comprise a catholyte. In some embodiments, the catholyte is a liquid catholyte.

In various further embodiments, the bilayer stack further comprises a first cathode seal and a second cathode seal. In some embodiments, the first cathode seal is in between the first solid-state electrolyte and the PECC. In some embodiments, the second cathode seal is in between the second solid-state electrolyte and the PECC.

In some further embodiments, the bilayer stack further comprises a first negative electrode seal between, and in contact with, the first NECC and the first metal layer. In some further embodiments, the bilayer stack further comprises a second negative electrode seal between, and in contact with, the second NECC and the second metal layer.

In certain further embodiments, a stack comprises two or more of the bilayer stacks.

In another aspect, a bilayer stack comprises a first negative electrode current collector (NECC); a first negative electrode seal; a first metal layer; a first solid-state electrolyte; a first cathode; a positive electrode current collector (PECC); a second cathode; a second solid-state electrolyte; a second metal layer; a second negative electrode seal; and a second NECC; wherein the first cathode and the second cathode are on opposite sides of, and in contact with, the PECC; wherein the first NECC is adjacent to first metal layer; and wherein the second NECC is adjacent to the second metal layer.

In some further embodiments, the first solid-state electrolyte and the second solid-state electrolyte each, individually in each instance, comprises lithium-stuffed garnet.

In certain further embodiments, the first solid-state electrolyte and the second solid-state electrolyte each, individually in each instance, is a film.

In various further embodiments, the first solid-state electrolyte may have a thickness in the range of 1 μm-100 μm, and the second solid-state electrolyte may have a thickness in the range of 1 μm-100 μm. For example, the thickness of the first and/or second solid-state electrolyte ranges from 1 μm-20 μm, 10 μm-20 μm, 20 μm-50 μm, 30 μm-60 μm, 25 μm-75 μm, 20 μm-80 μm, or 15 μm-30 μm.

In some further embodiments, the metal layer comprises nickel (Ni), iron (Fe), copper (Cu), platinum (Pt), gold (Au), silver (Ag), an alloy thereof, or a combination thereof.

In some further embodiments, the first solid-state electrolyte is in between the first metal layer and the first cathode. In some embodiments, the second solid-state electrolyte is in between the second metal layer and the second cathode.

In some further embodiments, the bilayer stack further comprises a first lithium metal layer between, and in contact with, the first solid-state electrolyte and the first metal layer. In some further embodiments, the bilayer stack further comprises a second lithium metal layer between, and in contact with, the second solid-state electrolyte and the second metal layer.

In some further embodiments, the first negative electrode seal is between, and in contact with, the first NECC and the first metal layer. In some embodiments, the second negative electrode seal is between, and in contact with, the second NECC and the second metal layer.

In some further embodiments, the bilayer stack further comprises a first cathode seal and a second cathode seal. In some embodiments, the first cathode seal is in between the first solid-state electrolyte and the PECC. In some embodiments, the second cathode seal is in between the second solid-state electrolyte and the PECC.

In various further embodiments, a stack comprises two or more bilayer stacks.

In another aspect, a bilayer stack comprises a first negative electrode current collector (NECC); a first negative electrode seal; a first metal layer; a first solid-state electrolyte; a first bonding layer; a first cathode; a positive electrode current collector (PECC); a second cathode; a second bonding layer; a second solid-state electrolyte; a second metal layer; a second negative electrode seal; and a second NECC; wherein the first cathode and the second cathode are on opposite sides of, and in contact with, the PECC; wherein the first NECC is adjacent to the first metal layer; and wherein the second NECC is adjacent to the second metal layer.

In some further embodiments, the first solid-state electrolyte and the second solid-state electrolyte each, individually in each instance, comprises lithium-stuffed garnet.

In certain further embodiments, the first solid-state electrolyte and the second solid-state electrolyte may each, individually in each instance, is a film.

In various further embodiments, the first solid-state electrolyte has a thickness in the range of 1 μm-100 μm, and the second solid-state electrolyte has a thickness in the range of 1 μm-100 μm. For example, the thickness of the first and/or second solid-state electrolyte ranges from 1 μm-20 μm, 10 μm-20 μm, 20 μm-50 μm, 30 μm-60 μm, 25 μm-75 μm, 20 μm-80 μm, or 15 μm-30 μm.

In some further embodiments, the metal layer comprises nickel (Ni), iron (Fe), copper (Cu), platinum (Pt), gold (Au), silver (Ag), an alloy thereof, or a combination thereof.

In some further embodiments, first bonding layer is between the first solid-state electrolyte and the first cathode. In some embodiments, the second bonding layer is between the second solid-state electrolyte and the second cathode.

In some further embodiments, the first solid-state electrolyte is between the first metal layer and the first bonding layer. In some further embodiments, the second solid-state electrolyte is between the second metal layer and the second bonding layer.

In some further embodiments, the bilayer stack further comprises a first buffer layer between, and in contact with, the first bonding layer and the first cathode. In some further embodiments, the bilayer stack further comprises a second buffer layer between, and in contact with, the second bonding layer and the second cathode.

In some further embodiments, the bilayer stack further comprises a first lithium metal layer between, and in contact with, the first solid-state electrolyte and the first metal layer. In some further embodiments, the bilayer stack further comprises a second lithium metal layer between, and in contact with, the second solid-state electrolyte and the second metal layer.

In some further embodiments, the first negative electrode seal is between, and in contact with, the first NECC and the first metal layer. In some embodiments, the second negative electrode seal is in between, and in contact with, the second NECC and the second metal layer.

In some further embodiments, the bilayer stack further comprises a first cathode frame and a second cathode frame. In some embodiments, the first cathode frame is in between the first solid-state electrolyte and the PECC. In some embodiments, the second cathode frame is in between the second solid-state electrolyte and the PECC.

In various further embodiments, a stack comprises two or more bilayer stacks.

### BRIEF DESCRIPTION OF THE DRAWINGS

FIG. 1 illustrates a structure of a battery bilayer stack according to various embodiments.

FIG. 2(a) illustrates a side view of a battery bilayer stack according to some embodiments.

FIG. 2(b) illustrates a top view of a battery bilayer stack according to certain embodiments.

FIG. 3 illustrates a structure of a battery bilayer stack according to some embodiments.

FIG. 4 illustrates a structure of a multi-layer battery stack according to various embodiments.

FIG. 5 is a diagram of major architectural components according to some embodiments.

FIG. 6 illustrates a side view of a battery bilayer stack according to some embodiments.

FIG. 7 illustrates a side view of a battery bilayer stack according to some embodiments.

FIG. 8 illustrates a side view of a battery bilayer stack according to some embodiments.

### DETAILED DESCRIPTION

The following description is presented to enable one of ordinary skill in the art to make and use the inventions set forth herein and to incorporate the instant disclosure in the context of particular applications. Various modifications, as well as a variety of uses in different applications will be readily apparent to those skilled in the art, and the general principles defined herein is applied to a wide range of embodiments. Thus, the present disclosure is not intended to be limited to the embodiments presented, but is to be accorded the widest scope consistent with the principles and novel features disclosed herein.

The reader's attention is directed to all papers and documents that are filed concurrently with this specification and are open to public inspection with this specification, and the content of all such papers and documents are incorporated herein by reference. Unless expressly stated otherwise, each feature disclosed is one example only of a generic series of equivalent or similar features.

Please note, if used, the labels left, right, front, back, top, bottom, forward, reverse, clockwise and counterclockwise have been used for convenience purposes only and are not intended to imply any particular fixed direction. Instead, they are used to reflect relative locations and/or directions between various portions of an object.

### Definitions

As used herein, the term “about,” when qualifying a number, e.g., about 15% percent by weight (w/w), refers to the number qualified and optionally the numbers included in a range about that qualified number that includes ±10% of the number. For example, about 15% w/w includes 15% w/w as well as 13.5% w/w, 14% w/w, 14.5% w/w, 15.5% w/w, 16% w/w, or 16.5% w/w. For example, “about 75° C.,” includes 75° C. as well 68° C., 69° C., 70° C., 71° C., 72° C., 73° C., 74° C., 75° C., 76° C., 77° C., 78° C., 79° C., 80° C., 81° C., 82° C., or 83° C.

As used herein, the phrase “current collector” refers to a component or layer in a secondary battery through which electrons conduct, to or from an electrode in order to complete an external circuit, and which are in direct contact with the electrode to or from which the electrons conduct. In some examples, the current collector is a metal (e.g., Al, Cu, or Ni, steel, alloys thereof, or combinations thereof) layer which is laminated to a positive or negative electrode. In some examples, the current collector is Al. In some examples, the current collector is Cu. In some examples, the current collector is Ni. In some examples, the current collector is steel. In some examples, the current collector is an alloy of Al. In some examples, the current collector is an alloy of Cu. In some examples, the current collector is an alloy of steel. In some examples, the current collector is Al. In some examples, the current collector is coated with carbon. In some examples, the current collector comprises a combination of the above metals. During charging and discharging, electrons move in the opposite direction to the flow of Li ions and pass through the current collector when entering or exiting an electrode.

As used herein, “selected from the group consisting of” refers to a single member from the group, more than one member from the group, or a combination of members from the group. For example, a member selected from the group consisting of A, B, and C can include A only, B only, or C only, as well as A and B, A and C, B and C, as well as A, B, and C.

As used herein, the phrases “electrochemical cell” or “battery cell” shall, unless specified to the contrary, mean a single cell including a positive electrode and a negative electrode, which have ionic communication between the two by way of an electrolyte. In some embodiments, a battery or module includes multiple positive electrodes and/or multiple negative electrodes enclosed in one container, e.g., a stack of electrochemical cells. A stack of electrochemical cells is referred to as a multi-layered cell. A symmetric cell is a cell having two Li metal anodes separated by a solid-state electrolyte.

As used herein, a “catholyte” refers to an ion conductor that is intimately mixed with, or that surrounds, or that contacts the positive electrode active material. Catholytes suitable with the embodiments described herein include, but are not limited to, catholytes having the common name LPS, LXPS, LXPSO, where X is Si, Ge, Sn, As, Al, LATS, or also Li-stuffed garnets, or combinations thereof, and the like. Catholytes may also be liquid, gel, semi-liquid, semi-solid, polymer, and/or solid polymer ion conductors. Catholytes include those catholytes set forth in US Patent Application Publication No. 2015-0171465, which published on Jun. 18, 2015, entitled SOLID STATE CATHOLYTE OR ELECTROLYTE FOR BATTERY USING Li_{A}MP_{B}S_{C} (M=Si, Ge, AND/OR Sn), filed May 15, 2014, the contents of which are incorporated by reference in their entirety. Catholytes include those catholytes set forth in US Patent Application Publication No. 2023/0327184, published on Oct. 12, 2023, entitled CATHOLYTES FOR A SOLID-STATE BATTERY, and filed May 18, 2023, the contents of which are incorporated by reference in their entirety.

As used herein, the phrase “liquid catholyte” refers to an ion conductor that is intimately mixed with, or surrounded by, a cathode active material and is a liquid.

As used herein, the phrase “solid catholyte” or “solid-state catholyte” refers to an ion conductor that is intimately mixed with, or surrounded by, a cathode active material and is a solid.

As used herein, the term “electrolyte,” refers to an ionically conductive and electrically insulating material. Electrolytes are useful for electrically insulating the positive and negative electrodes of a secondary battery while allowing for the conduction of ions, e.g., Lit, through the electrolyte. Electrolytes are ionically conductive and electrically insulating material. Electrolytes are useful for electrically insulating the cathode and anode of a secondary battery while allowing for the conduction of ions, e.g., Lit, through the electrolyte.

As used herein, the term “solid-state electrolyte” or “solid-state electrolyte separator,” are used interchangeably and refer to a material that does not include carbon and which conducts Li⁺ ions, that is substantially insulating to electrons (e.g., the lithium ion conductivity is at least 10³ times, and often 10⁶ times, greater than the electron conductivity), and which acts as a physical barrier or spacer between the cathode and anode electrodes in an electrochemical cell or a rechargeable battery. In one embodiment, the separator is a thin film garnet separator, for example, a lithium-stuffed garnet thin film. In one embodiment, the separator is a bare film. In one embodiment, the separator is a film-on-foil film.

As used herein, the term “thin film” refers to a film having the components, compositions, or materials described herein where the film has an average thickness dimension of about 10 nm to about 100 μm. In some examples, thin refers to a film that is greater than about 10 nm and less than about 1 μm, 10 μm, or 50 μm in thickness.

As used herein, the phrase “electrochemical stack” or the term “stack” refers to one or more units, each of which includes at least a negative electrode (e.g., Li, LiC₆), a positive electrode (e.g., FeF₃, NiFₓ wherein x is 2 or 3, nickel-cobalt aluminum oxide (NCA), lithium iron phosphate (LFP), LiNiₓMn_{y}CO_{z}O₂, [NMC] or LiNiₓAl_{y}Co_{z}O₂ [NCA], wherein x+y+z=1; and wherein 0≤x≤1; 0≤y≤1; and 0≤z≤1), optionally combined with a solid-state electrolyte or a gel electrolyte), and a solid-state electrolyte (e.g., an oxide electrolyte set forth herein such as a lithium-stuffed garnet (e.g., Li₇La₃Zr₂O₁₂)) between and in contact with the positive and negative electrodes. In some examples, between the solid-state electrolyte and the positive electrode, there is an additional layer comprising a compliant electrolyte (e.g., gel electrolyte, gel polymer electrolyte). An electrochemical stack may include one of these aforementioned units. An electrochemical stack may include several of these aforementioned units arranged in electrical communication (e.g., serial or parallel electrical connection).

As used herein, the phrase “positive electrode” refers to the electrode in a secondary battery towards which positive ions, e.g., Li⁺, conduct, flow, or move during discharge of the battery. As used herein, the phrase “negative electrode” refers to the electrode in a secondary battery from which positive ions, e.g., Li⁺ flow, or move during discharge of the battery. In a battery comprised of a Li-metal electrode and a conversion chemistry, intercalation chemistry, or combination of conversion/intercalation chemistry-including electrode (i.e., cathode active material), the electrode having the conversion chemistry, intercalation chemistry, or combination of conversion/intercalation chemistry material is referred to as the positive electrode. In some usage, cathode is used in place of positive electrode, and anode is used in place of negative electrode. When a Li-secondary battery is charged, Li ions move from the positive electrode (e.g., NiFₓ, NMC, NCA) towards the negative electrode (e.g., Li-metal). When a Li-secondary battery is discharged, Li ions move towards the positive electrode and from the negative electrode.

As used herein, the phrase “lithium-stuffed garnet” refers to oxides that are characterized by a crystal structure related to a garnet crystal structure. Lithium-stuffed garnets include compounds having the formula Li_{A}La_{B}M′_{c}M″_{D}Zr_{E}O_{F}, Li_{A}La_{B}M′_{C}M″_{D}Ta_{E}O_{F}, or Li_{A}La_{B}M′_{C}M″_{D}Nb_{E}O_{F}, wherein 4<A<8.5, 1.5<B<4, 0≤C≤2, 0≤D≤2; 0≤E≤2, 10<F<13, and M′ and M″ are each, independently in each instance selected from Al, Mo, W, Nb, Sb, Ca, Ba, Sr, Ce, Hf, Rb, Ta, and Ga, or LiₐLa_{b}Zr_{c}Al_{d}Me″ₑO_{f}, wherein 5<a<7.7; 2<b<4; 0<c≤2.5; 0≤d<2; 0≤e<2, 10<f<13 and Me″ is a metal selected from Nb, Ta, V, W, Mo, Sb, and Ga and as described herein. Garnets, as used herein, also include those garnets described above that are doped with Al₂O₃. Garnets, as used herein, also include those garnets described above that are doped so that Al³⁺ substitutes for Li⁺. As used herein, lithium-stuffed garnets, and garnets, generally, include, but are not limited to, Li_{7.0}La₃(Zrₜ₁+Nbₜ₂+Taₜ₃)O₁₂+0.35Al₂O₃; wherein (t1+t2+t3=subscript 2) so that the La:(Zr/Nb/Ta) ratio is 3:2. Also, garnet used herein includes, but is not limited to, LiₓLa₃Zr₂O₁₂+yAl₂O₃, wherein x ranges from 5.5 to 9; and y ranges from 0 to 1. In some examples, x is 7 and y is 1.0. In some examples, x is 7 and y is 0.35. In some examples, x is 7 and y is 0.7. In some examples, x is 7 and y is 0.4. Also, garnets as used herein include, but are not limited to, LiₓLa₃Zr₂O₁₂+yAl₂O₃.

As used herein, garnet does not include YAG-garnets (i.e., yttrium aluminum garnets, or, e.g., Y₃Al₅O₁₂). As used herein, garnet does not include silicate-based garnets such as pyrope, almandine, spessartine, grossular, hessonite, or cinnamon-stone, tsavorite, uvarovite and andradite and the solid solutions pyrope-almandine-spessartite and uvarovite-grossular-andradite. Garnets herein do not include nesosilicates having the general formula X₃Y₂(SiO₄)₃ wherein X is Ca, Mg, Fe, and, or, Mn; and Y is Al, Fe, and, or, Cr.

As used herein, the phrase “electrochemical device” refers to an energy storage device, such as, but not limited to a Li-secondary battery that operates or produces electricity or an electrical current by an electrochemical reaction.

As used herein, the phrase “film thickness” refers to the distance, or median measured distance, between the top and bottom faces of a film. As used herein, the top and bottom faces refer to the sides of the film having the largest geometric surface area.

As used herein, the term “surface” refers to material that is at an interface between two different phases, chemicals, or states of matter. For example, a solid-state electrolyte separator when exposed to air has a surface described by the periphery or outside portion of the separator that contacts the air. For rectangular-shaped film separators, there is a top and a bottom surface (or major surfaces) which both individually have higher surface areas than each of the four side surfaces (or minor surfaces) individually. In this rectangular separator example, there are also four side surfaces which have surface areas less than either or both of the top and bottom surfaces. For disc-shaped film separators, there is a top and a bottom surface which both individually have higher surface areas than the circumference-side of the disc. When used as an electrolyte separator in an electrochemical cell, the top or bottom surface is the side or part of the separator that contacts the anode (i.e., Li metal), the cathode or catholyte in cathode, and/or a layer or bonding agent disposed between the electrolyte separator and the cathode. A surface has larger x- and y-axis physical dimensions than it does z-axis physical dimensions, wherein the z-axis is the axis perpendicular to the surface. The depth or thickness of a surface can be of molecular order of magnitude or up to 1 micron. Film surfaces can include dangling bonds, excess hydroxyl groups, bridging oxides, or a variety of other species which result in the film surface having a chemical composition that may be stoichiometrically different from the bulk. As used herein, the term “bulk,” refers to a portion or part of the film that is extended in space in three-dimensions by at least 1 micron. The bulk refers to the portion or part of a material which is exclusive of its surface, as defined above.

As used herein, the phrase “cathode active material” refers to a material which can intercalate lithium ions or react with lithium ions in a reversible manner. The cathode active material is not particularly limited herein, and cathode active material utilized in all-solid-state batteries can be used. Specific examples of such a cathode active material include the following: manganese oxide (MnO), iron oxides, copper oxides, nickel oxides, lithium-manganese complex oxides (e.g., LiMn₂O₄ or LiMnO₂), lithium-nickel complex oxides (e.g., LiNiO₂), lithium-cobalt complex oxides (e.g. LiCoO₂), lithium cobalt nickel oxides (LiNi_{1-y}Co_{y}O₂), lithium-manganese-cobalt complex oxides (e.g., LiMn_{y}Co_{1-y}O₂), lithium-nickel-manganese-cobalt oxides (e.g. LiNiₓMn_{y}CO_{1-x-y}O₂), lithium-nickel-cobalt-aluminum oxides (e.g. LiNiₓAl_{y}Co_{1-x-y}O₂), spinel-phase lithium-manganese-nickel complex oxides (e.g., LiMn_{1.5}Ni_{0.5}O₄), lithium phosphates having an olivine structure (e.g., LiFePO₄, LiCoPO₄), lithium phosphates having a NASICON-type structure (e.g., Li₇V₂(PO₄)₃), iron (III) sulfate (Fe₂(SO₄)₃), and vanadium oxides (e.g., V₂O₅). One type thereof can be used alone, or two or more types thereof can be used in combination. Preferably, x and y in these chemical formulas lie within the ranges of 0<x<1, and 0<y<1.

Additional examples of cathode active material include LiMPO₄ (M=Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al₂O₂, wherein x+y+z=1, and 0≤x≤1, 0≤y≤1, and 0≤z≤1. In these formula, x, y, and z are chosen so that the formula is charge neutral. In one embodiment, the cathode active material is selected from a member of the NMC class of cathode active materials (including, but not limited to, LiNiₓCo_{y}Mn₂O₂, wherein x+y+z=1); the LFP class of cathode active materials (including, but not limited to, LiFePO₄/C); the LNMO class of cathode active materials (including, but not limited to, LiNi_{0.5}Mn_{1.5}O₄); the NCA class of cathode active materials (including, but not limited to, LiMn₂O₄ and LiMn₂O₂); the LMO class of cathode active materials (including, but not limited to, LiMn₂O₄); the LCO class of cathode active materials (including, but not limited to, LiCoO₂).

As used herein, the terms “cathode” and “anode” refer to the electrodes of a battery. The cathode and anode are often referred to in the relevant field as the positive electrode and negative electrode, respectively.

As used herein, the phrase “solid-state cathode” refers to a cathode which does not include a liquid-phase electrolyte.

As used herein, the term “buffer” or “buffer layer” refers to a single ion conducting, solid-state electrolyte that is finely mixed within or combined with the positive electrode components or is a layer which is in direct contact with the positive electrode, e.g., an electrolyte layer laminated to the positive electrode layer. Single ion conducting means that the material only conducts one type of ion, e.g., a Lit ion with a transference number of greater than 0.9. Solid-state means that the buffer exists in the solid phase at ambient temperatures and pressures.

As used herein, the phrase “buffer is mixed within the positive electrode layer,” means that the buffer material is ground up, e.g., milled, and then mixed with the other positive electrode layer compounds, e.g., active material and conductive carbon, when the positive electrode layer is formed.

As used herein, the phrase “bonding layer” refers to a layer which includes a borohydride compound and which adheres a lithium-stuffed garnet layer to a sulfide electrolyte layer or sulfide including buffer. The borohydride is any compound set forth in WO 2018/075972, which published Apr. 26, 2018, and was filed as International PCT Patent Application No. PCT/US2017/057735, and is entitled ELECTROLYTE SEPARATORS INCLUDING LITHIUM BOROHYDRIDE AND COMPOSITE ELECTROLYTE SEPARATORS OF LITHIUM-STUFFED GARNET AND LITHIUM BOROHYDRIDE, the entire contents of which are incorporated by reference herein in their entirety for all purposes. The borohydride is any compound set forth in WO2019078897A1, which published Apr. 25, 2019, and was filed as International PCT Patent Application No. PCT/US2017/057739, filed Oct. 20, 2017, and is entitled BOROHYDRIDE-SULFIDE INTERFACIAL LAYER IN ALL SOLID STATE BATTERY, the entire contents of which are incorporated by reference herein in their entirety for all purposes.

As used herein, a “thickness” by which a film is characterized refers to the shortest, perpendicular distance, or median shortest, perpendicular measured distance, between the top and bottom faces of a film. As used herein, the major surfaces (or top and bottom faces) refer to the sides of the film having the largest surface areas. As used herein, electrolyte separator or membrane thickness is measured by cross-sectional scanning electron microscopy.

As used herein, a “unit stack,” is a stack that may include, in sequence, an anode current collector, solid-state separator, cathode, and cathode current collector. A stack may optionally include lithium metal between the anode current collector and the solid-state separator.

As used herein, a “bilayer stack,” is a stack that may include two unit stacks that share a cathode current collector or two unit stacks that share an anode current collector.

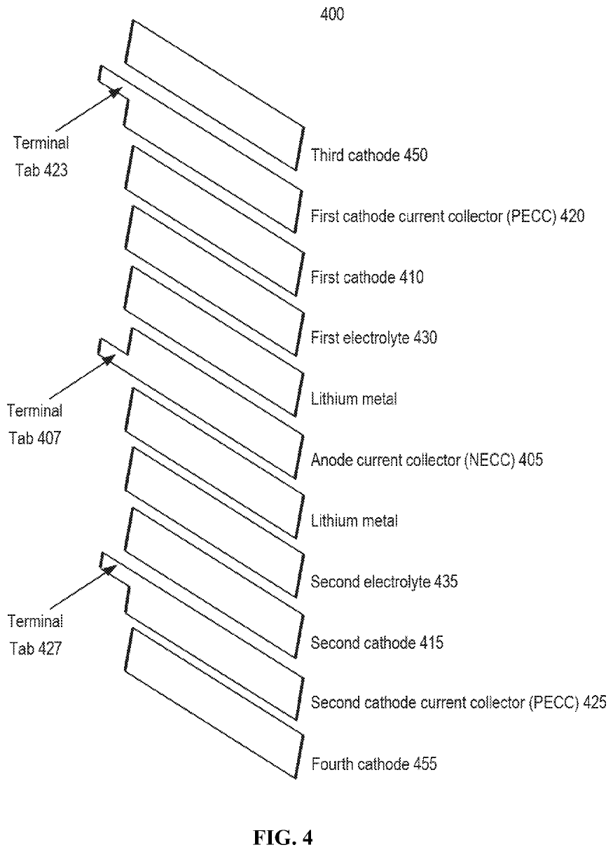

As used herein, a “multilayer stack,” is a combination of multiple unit stacks and bilayer stacks. For example, a multilayer stack may include two bilayer stacks that share an anode current collector layer, as depicted in FIG. 4. In various embodiments, a multilayer stack may include up to 100 bilayer stacks.

As used herein, a “uniform cathode surfaces,” refers to the surface of a cathode that has the same properties as the bulk of the cathode. For example, when the porosity of the surface of the cathode is the same as the porosity of the bulk of the cathode, the cathode has a uniform cathode surface. For example, when the composition of the surface of the cathode is the same as the composition of the bulk of the cathode, the cathode has a uniform cathode surface. For example, when the surface roughness is less than 5 μm, the cathode has a uniform cathode surface. In some examples, a uniform cathode surface is a surface of a cathode that has the same porosity and composition as the bulk. In some examples, a uniform cathode surface is a surface of a cathode that has the same porosity and composition as the bulk and the surface roughness of the cathode is less than 5 μm. Porosity is measured by scanning electron microscopy. Composition is analyzed using x-ray photoelectron spectroscopy or electrode dispersive x-ray spectroscopy. Surface roughness is measured using atomic force microscopy.

Disclosed herein are lithium stuffed garnet-based thin films that have grains therein, for example, less than 10 μm in physical dimensions. In some examples, these films are less than 50 μm in film thickness and greater than 10 nm. In some examples, the films have a high conductivity, which in some examples is greater than 10⁻⁴ S/cm. In some examples, the films are strong, have good mechanical integrity, and prevent the ingress of lithium dendrites when used as an electrolyte in lithium secondary batteries.

In other examples, set forth herein are a number of lithium stuffed garnet compositions that are doped with alumina and which possess the unique combination of high ionic conductivity and fine grain size. In some examples, these compositions are prepared under lower temperatures and shorter reaction time conditions than were previously known possible for lithium stuffed garnets. In addition, in some examples, by using finely milled garnet powder, and, or garnet precursors, and, or, metal powders, unique thin film architectures are prepared as set forth below. The disclosure herein sets forth a number of novel lithium-stuffed garnet ceramics having aluminum therein, e.g., as alumina (Al₂O₃), which advantageously and surprisingly have high ionic conductivity and small grain size properties.

In some embodiments, the garnet material described herein is used as an electrolyte. In some of these embodiments, the garnet has the formula LiₓLa₃Zr₂O₁₂·y½Al₂O₃; wherein 5.0<x<9 and 0.1<y<1.5. In some of these examples, the electrolyte is LiₓLa₃Zr₂O₁₂·0.35Al₂O₃. In other of these examples, the electrolyte is Li₇La₃Zr₂O₁₂·0.35Al₂O₃.

In some of the examples wherein the garnet is an electrolyte, the garnet does not include any Nb, Ta, W or Mo, which is used herein to mean that the concentration of those elements (e.g., Nb, Ta, W, or Mo) is 10 parts per million (ppm) or lower. In some examples, the concentration of those elements (e.g., Nb, Ta, W, or Mo) is 1 part per million (ppm) or lower. In some examples, the concentration of those elements (e.g., Nb, Ta, W, or Mo) is 0.1 parts per million (ppm) or lower.

In some examples, the alumina doped Li₇La₃Zr₂O₁₂ (LLZO) has a high conductivity, e.g., greater than 10-4 S/cm at room temperature.

In some examples, the garnet-based composition is doped with 0.3, 0.35, 0.4, 0.45, 0.5, 0.55, 0.6, 0.65, 0.7, 0.75, 0.8, 0.85, 0.9, 0.95, or 1 molar amount of Al per LiₓA₃B₂O₁₂.

In the examples, herein, the subscripts and molar coefficients in the empirical formulas are based on the quantities of raw materials initially batched to make the described examples.

In some examples, the instant disclosure provides a composition including a lithium stuffed garnet and Al₂O₃. In certain examples, the lithium stuffed garnet is doped with alumina. In some examples, the lithium-stuffed garnet is characterized by the empirical formula Li_{A}La_{B}M′_{c}M″_{D}Zr_{E}O_{F}, wherein 4<A<8.5, 1.5<B<4, 0≤C≤2, 0≤D≤2; 0≤E≤2, 10<F≤13, and M′ and M″ are, independently in each instance, either absent or are each independently selected from Al, Mo, W, Nb, Sb, Ca, Ba, Sr, Ce, Hf, Rb, or Ta; and wherein the molar ratio of Garnet:Al₂O₃ is between 0.05 and 0.7.

In some examples, the instant disclosure provides a composition including a lithium stuffed garnet and Al₂O₃. In certain examples, the lithium stuffed garnet is doped with alumina. In some examples, the lithium-stuffed garnet is characterized by the empirical formula Li_{A}La_{B}M′_{c}M″_{D}Zr_{E}O_{F}, wherein 4<A<8.5, 1.5<B<4, 0≤C≤2, 0≤D≤2; 0≤E≤2, 10<F≤13, and M′ and M″ are, independently in each instance, either absent or are each independently selected from Al, Mo, W, Nb, Sb, Ca, Ba, Sr, Ce, Hf, Rb, Ta, and Ga; and wherein the molar ratio of Li:Al is between 0.05 and 0.7.

In some examples, the lithium stuffed garnet is a lithium stuffed garnet set forth in US Patent Application Publication No. US 2015-0099190, entitled GARNET MATERIALS FOR LI SECONDARY BATTERIES AND METHODS OF MAKING AND USING GARNET MATERIALS, filed Oct. 7, 2014, and U.S. Non-Provisional Patent Application Publication No. US 2015-0099188, GARNET MATERIALS FOR LI SECONDARY BATTERIES AND METHODS OF MAKING AND USING GARNET MATERIALS, filed Oct. 7, 2014, the entire contents of which are herein incorporated by reference in its entirety for all purposes.

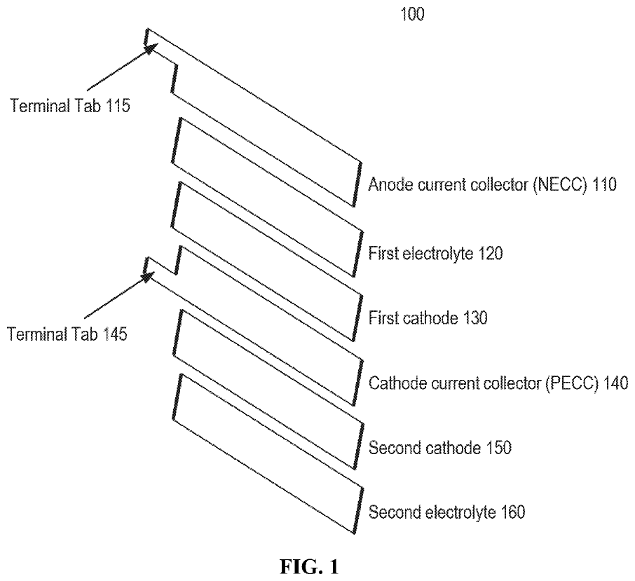

FIG. 1 illustrates an expanded view example embodiment of bilayer stack 100, which may include a plurality of layers. For example, bilayer stack 100 may include anode negative electrode current collector (NECC) 110 and cathode positive electrode current collector (PECC) 140. NECC 110 and/or PECC 140 may each include terminal tabs 115 and 145, respectively, which extend beyond the main body of NECC 110 and/or PECC 140, as illustrated in FIG. 1. In addition, first cathode 130 and second cathode 150 is disposed on opposite sides of, and in contact with, PECC 140. Furthermore, first solid-state electrolyte 120 is disposed between NECC 110 and first cathode 130. Additionally, second solid-state electrolyte 160 is disposed adjacent to second cathode 150, such as on the side of second cathode 150 opposite from PECC 140.

In various embodiments, first solid-state electrolyte 120 and/or second solid-state electrolyte 160 may each include lithium-stuffed garnet. Additionally, or alternatively, first solid-state electrolyte 120 and/or second solid-state electrolyte 160 may each be a film. In some embodiments, first solid-state electrolyte 120 and/or second solid-state electrolyte 160 may have a thickness of, for example, less than 100 μm.

In some embodiments, bilayer stack 100 may further include lithium metal disposed between NECC 110 and first solid-state electrolyte 120. In certain embodiments, lithium metal is disposed on an upper and lower side of NECC 110.

In various embodiments, first solid-state electrolyte 120 and/or second solid-state electrolyte 160 may include a cathode seal. In certain embodiments, a seal is disposed between NECC 110 and first solid-state electrolyte 120. Similarly, a seal is disposed on the opposite side of second electrolyte 160 from second cathode 150.

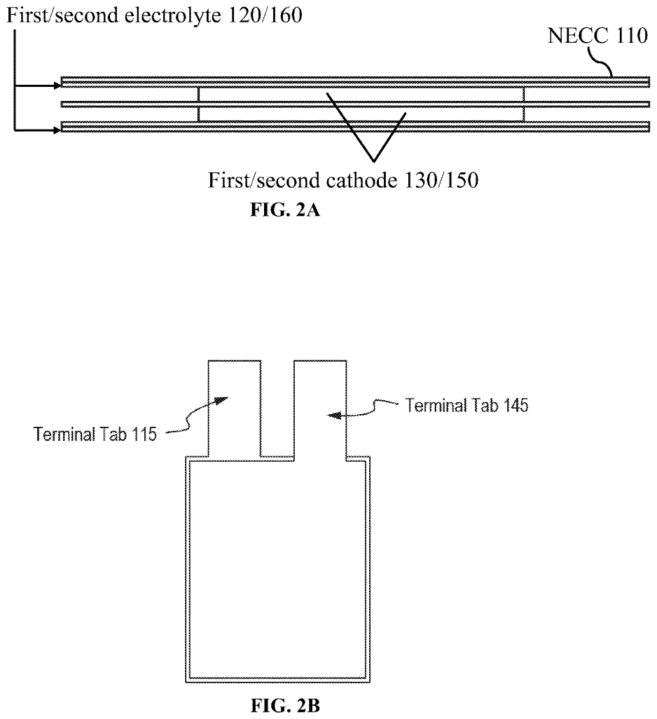

In certain embodiments, the plurality of layers of bilayer stack 100 is combined into a stack. For example, FIG. 2(a) illustrates a side-view of the plurality of layers combined into bilayer stack 100. Similarly, FIG. 2(b) illustrates a top view of bilayer stack 100, in which each of the plurality of layers are aligned into a single unit, with the terminals of NECC 110 and/or PECC 140 extending beyond the main body of bilayer stack 100.

In some embodiments, the plurality of layers of bilayer stack 100 is pressurized within a housing (not depicted in FIG. 1). For example, the plurality of layers of bilayer stack 100 is pressurized within a housing with one or more noble gases, such as helium (He), neon (Ne), argon (Ar), krypton (Kr), xenon (Xe), and the radioactive radon (Rn). Alternatively or additionally, the plurality of layers of bilayer stack 100 is pressurized within the housing with one or more other inert gases. Furthermore, the plurality of layers of bilayer stack 100 is pressurized within the housing at any pressure, such as in the range of 100 PSI-1,000 PSI.

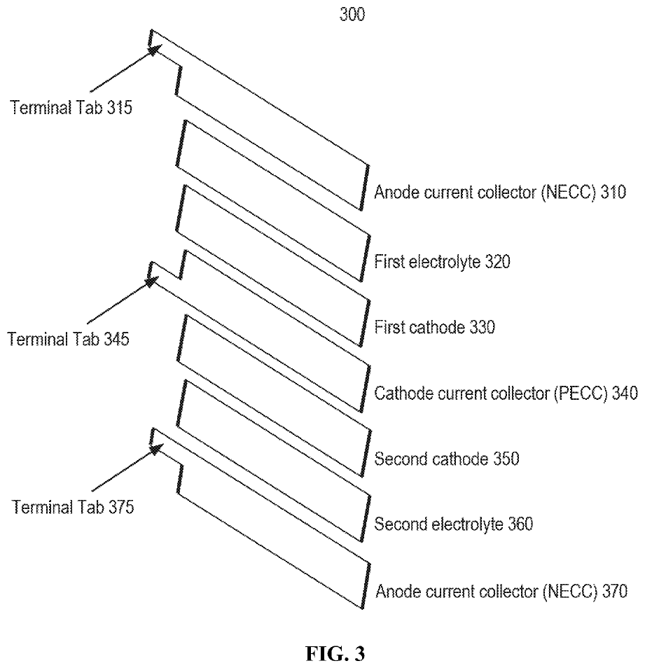

FIG. 3 illustrates bilayer stack 300, which is similar to bilayer stack 100 illustrated in FIG. 1. However, bilayer stack 300 may also include NECC 370 (with terminal tab 375) disposed on the side of second electrolyte 360 opposite from second cathode 350.

FIG. 4 illustrates an example embodiment of multilayer stack 400, which may include a plurality of layers. For example, multilayer stack 400 may include NECC 405, first cathode 410, and second cathode 415. Multilayer stack 400 may further include first PECC 420 and second PECC 425. Furthermore, multilayer stack 400 may include first solid-state electrolyte 430 and second solid-state electrolyte 435 on opposite sides of NECC 405. As an example, first cathode 410 is disposed between first solid-state electrolyte 430 and first PECC 420. Similarly, second cathode 415 is disposed between second solid-state electrolyte 435 and second PECC 425. In certain embodiments, a stack may include two or more bilayer stacks similar to multilayer stack 400. NECC 405, PECC 420, and/or PECC 425 may each include terminal tabs 407, 423, and 427, respectively, which extend beyond the main body of NECC 405, PECC 420, and/or PECC 425, as illustrated in FIG. 4.

In some embodiments, first solid-state electrolyte 430 and second solid-state electrolyte 435 may include lithium-stuffed garnet. Similarly, first solid-state electrolyte 430 and second solid-state electrolyte 435 may each be, individually in each instance, a film. In various embodiments, first solid-state electrolyte 430 may have a thickness less than 100 μm and greater than 10 nm, and second solid-state electrolyte 435 may have a thickness less than 100 μm and greater than 10 nm.

In certain embodiments, multilayer stack 400 may also include lithium metal on two sides of NECC 405. For example, the lithium metal is between and in contact with first solid-state electrolyte 430 and NECC 405. Similarly, lithium metal is between and in contact with second solid-state electrolyte 435 and NECC 405.

In some embodiments, first cathode 410 and second cathode 415 may each, individually in each instance, include a cathode seal. Furthermore, multilayer stack 400 may include third cathode 450 on the side of first PECC 420 opposite first cathode 410. Similarly, multilayer stack 400 may include fourth cathode 455 on the side of second PECC 425 opposite second cathode 415.

In various embodiments, multilayer stack 400 may also include a seal between NECC 405 and first solid-state electrolyte 430, and/or may include a seal between NECC 405 and second solid-state electrolyte 435. Furthermore, first solid-state electrolyte 430 may have a thickness in the range of 1 μm-100 μm, and/or second solid-state electrolyte 435 may have a thickness in the range of 1 μm-100 μm. For example, the thickness of first solid-state electrolyte 430 and/or second solid-state electrolyte 435 ranges from 1 μm-20 μm, 10 μm-20 μm, 20 μm-50 μm, 30 μm-60 μm, 25 μm-75 μm, 20 μm-80 μm, and 15 μm-30 μm.

In various embodiments, multilayer stack 400 may also include a seal disposed between first electrolyte 430 and NECC 405, and/or a seal disposed between second electrolyte 435 and NECC 405. As an example, these seals is lithium-ion or lithium metal conductive seals.

In some embodiments, the plurality of layers of multilayer stack 400 is pressurized within a housing (not depicted in FIG. 4). For example, the plurality of layers of multilayer stack 400 is pressurized within a housing with one or more noble gases, such as helium (He), neon (Ne), argon (Ar), krypton (Kr), xenon (Xe), and the radioactive radon (Rn). Alternatively or additionally, the plurality of layers of multilayer stack 400 is pressurized within the housing with one or more other inert gases. Furthermore, the plurality of layers of multilayer stack 400 is pressurized within the housing at any pressure, such as between 1-1000 kiloPascal (kPa).

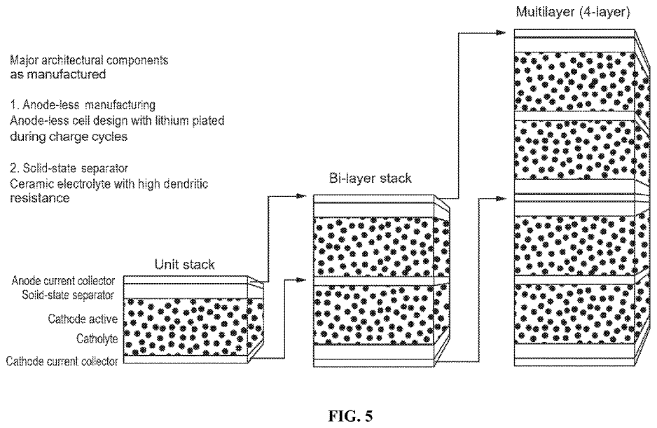

FIG. 5 illustrates an example of a unit stack, bi-layer stack, and multilayer (4-layer) stack, such as multilayer 400. One benefit of the design in FIG. 5 is manufacturing unit stacks, bilayer stacks, and multilayer stacks that do not require lithium metal at the time of manufacturing. Rather, the lithium is added with the cathode (e.g., lithiated nickel manganese cobalt oxide) during manufacturing. Then, lithium is plated during charge cycles between the NECC and the solid-state electrolyte. This is called anode-less manufacturing.

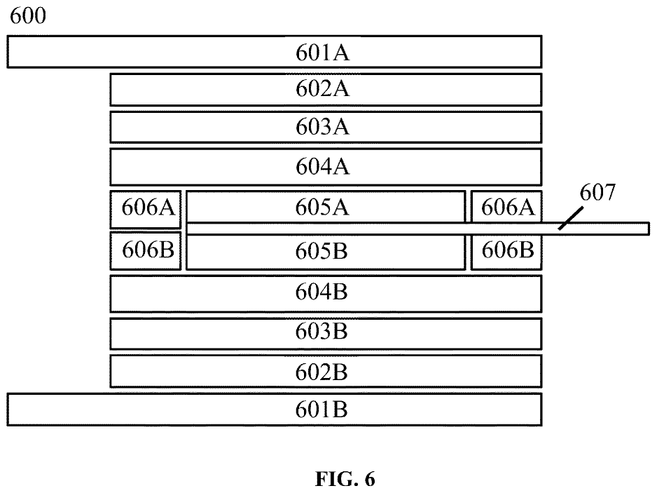

FIG. 6 illustrates a cross-sectional view embodiment of bilayer stack 600, which may include a plurality of layers. For example, bilayer stack 600 may include a first anode negative electrode current collector (NECC) 601A, a second NECC 601B, and positive electrode current collector (PECC) 607. In addition, first cathode 605A and second cathode 605B is disposed on opposite sides of, and, in contact with, PECC 607.

Bilayer stack 600 may include a first metal layer 603A and a second metal layer 603B. Furthermore, first solid-state electrolyte 604A is disposed between first metal layer 603A and first cathode 605A. Additionally, second solid-state electrolyte 604B is disposed adjacent to second cathode 605B, such as on the side of second cathode 605B opposite from PECC 607.

Bilayer stack 600 may include a first cathode seal 606A and a second cathode seal 606B. Furthermore, the first cathode seal 606A is disposed between, and in various embodiments, in contact with the first solid-state electrolyte 604A and PECC 607. Additionally, the second cathode seal 606B is disposed between, and in various embodiments, in contact with the second solid-state electrolyte 604B and the PECC 607. Additionally, the first cathode seal 606A is adjacent to the minor surfaces of first cathode 605A, and in some embodiments, not contact the minor surfaces of the first cathode. Additionally, the second cathode seal 606B is adjacent to the minor surfaces of second cathode 605B, and in some embodiments, not contact the minor surfaces of the second cathode. In some embodiments, the first cathode seal 606A, is a ring seal and is located in proximity to the perimeter of the first solid-state electrolyte. In some embodiments, the second cathode seal 606B, is a ring seal and is located in proximity to the perimeter of the first solid-state electrolyte.

Additionally, bilayer stack 600 may include a first negative electrode seal 602A and a second negative electrode seal 602B. The first negative electrode seal is disposed between, and in contact with the first metal layer 603A and the first NECC 601A. Furthermore, the second negative electrode seal is disposed between, and in some embodiments, in contact with the second metal layer 603B and the second NECC 601B.

In some embodiments, bilayer stack 600 may further include lithium metal disposed between, and in some embodiments, in contact with first metal layer 603A and first solid-state electrolyte 604A. In further embodiments, bilayer stack 600 may further include lithium metal disposed between, and in contact with second metal layer 603B and first solid-state electrolyte 604B.

In various embodiments, first solid-state electrolyte 604A and/or second solid-state electrolyte 604B may each include lithium-stuffed garnet. Additionally or alternatively, first solid-state electrolyte 604A and/or second solid-state electrolyte 604B may each be a film. In some embodiments, first solid-state electrolyte 604A and/or second solid-state electrolyte 604B may have a thickness of, for example, less than 100 μm. Furthermore, first solid-state electrolyte 604A may have a thickness in the range of 1 μm-100 μm, and/or second solid-state electrolyte 604B may have a thickness in the range of 1 μm-100 μm. For example, the thickness of first solid-state electrolyte 604A and/or second solid-state electrolyte 604B ranges from 1 μm-20 μm, 10 μm-20 μm, 20 μm-50 μm, 30 μm-60 μm, 25 μm-75 μm, 20 μm-80 μm, and 15 μm-30 μm.

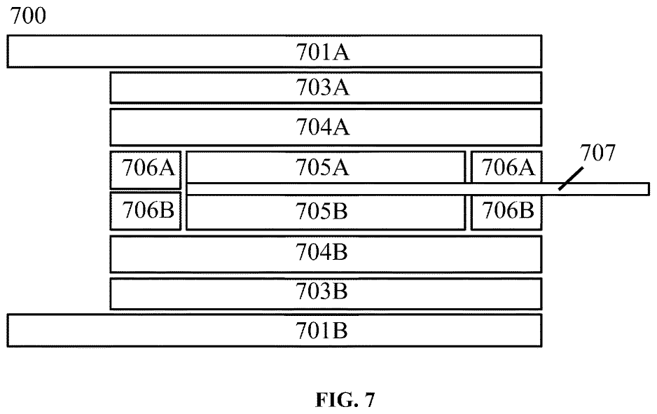

FIG. 7 illustrates a cross-sectional view example embodiment of bilayer stack 700, which may include a plurality of layers. For example, bilayer stack 700 may include a first anode negative electrode current collector (NECC) 701A, a second NECC 701B, and cathode positive electrode current collector (PECC) 707. In addition, first cathode 705A and second cathode 705B is disposed on opposite sides of, and, in contact with, PECC 707.

Bilayer stack 700 may include a first metal layer 703A and a second metal layer 703B. Furthermore, first solid-state electrolyte 704A is disposed between first metal layer 703A and first cathode 705A. Additionally, second solid-state electrolyte 704B is disposed adjacent to second cathode 705B, such as on the side of second cathode 705B opposite from PECC 707.

Bilayer stack 700 may include a first cathode seal 706A and a second cathode seal 706B. Furthermore, the first cathode seal 706A is disposed between, and in various embodiments, in contact with the first solid-state electrolyte 704A and PECC 707. Additionally, the second cathode seal 706B is disposed between, and in various embodiments, in contact with the second solid-state electrolyte 704B and the PECC 707. Additionally, the first cathode seal 706A is adjacent to the minor surfaces of first cathode 705A, and in some embodiments, not contact the minor surfaces of the first cathode. Additionally, the second cathode seal 706B is adjacent to the minor surfaces of second cathode 705B, and in some embodiments, not contact the minor surfaces of the second cathode. In some embodiments, the first cathode seal 706A, is a ring seal and is located in proximity to the perimeter of the first solid-state electrolyte. In some embodiments, the second cathode seal 706B, is a ring seal and is located in proximity to the perimeter of the first solid-state electrolyte.

In some embodiments, bilayer stack 700 may further include lithium metal disposed between, and in some embodiments, in contact with first metal layer 703A and first solid-state electrolyte 704A. In further embodiments, bilayer stack 700 may further include lithium metal disposed between, and in some embodiments, in contact with second metal layer 703B and first solid-state electrolyte 704B.

In various embodiments, first solid-state electrolyte 704A and/or second solid-state electrolyte 704B may each include lithium-stuffed garnet. Additionally or alternatively, first solid-state electrolyte 704A and/or second solid-state electrolyte 704B may each be a film. In some embodiments, first solid-state electrolyte 704A and/or second solid-state electrolyte 704B may have a thickness of, for example, less than 100 μm. Furthermore, first solid-state electrolyte 704A may have a thickness in the range of 1 μm-100 μm, and/or second solid-state electrolyte 704B may have a thickness in the range of 1 μm-100 μm. For example, the thickness of first solid-state electrolyte 704A and/or second solid-state electrolyte 704B ranges from 1 μm-20 μm, 10 μm-20 μm, 20 μm-50 μm, 30 μm-60 μm, 25 μm-75 μm, 20 μm-80 μm, or 15 μm-30 μm.

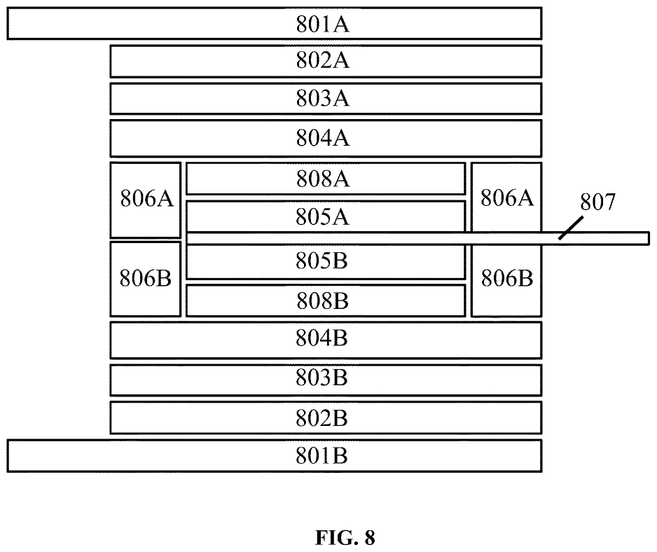

FIG. 8 illustrates a cross-sectional view example embodiment of bilayer stack 800, which may include a plurality of layers. For example, bilayer stack 800 may include a first anode negative electrode current collector (NECC) 801A, a second NECC 801B, and cathode positive electrode current collector (PECC) 807. In addition, first cathode 805A and second cathode 805B is disposed on opposite sides of, and, in contact with, PECC 807.

Bilayer stack 800 may include a first bonding layer 808A and a second bonding layer 808B. Furthermore, first bonding layer 808A is disposed between first solid-state electrolyte 804A and first cathode 805A. In addition, second bonding layer 808B is disposed between second solid-state electrolyte 804B and second cathode 805B.

Bilayer stack 800 may further include a first buffer layer (not shown) and a second buffer layer (not shown). The first buffer layer is disposed between, and in contact with first bonding layer 808A and first cathode 805A. Additionally, the second buffer layer is disposed between, and in contact with second bonding layer 808B and second cathode 805B.

Bilayer stack 800 may include a first metal layer 803A and a second metal layer 803B. Furthermore, first solid-state electrolyte 804A is disposed between first metal layer 803A and first bonding layer 808A. Additionally, second solid-state electrolyte 804B is disposed between the second metal layer 803B and second bonding layer 808A.

Bilayer stack 800 may include a first cathode frame 806A and a second cathode frame 806B. Furthermore, the first cathode frame 806A is disposed between, and in various embodiments, in contact with the first solid-state electrolyte 804A and PECC 807. Additionally, the second cathode frame 806B is disposed between, and in various embodiments, in contact with the second solid-state electrolyte 804B and the PECC 807. Furthermore, the first cathode frame 806A is adjacent to the minor surfaces of first cathode 805A, and/or the minor surfaces of the first bonding layer 808A. In some embodiments, the first cathode frame 806A does not contact the minor surfaces of the first cathode. In some embodiments, the first cathode frame 806A does not contact the minor surfaces of the first bonding layer. In some embodiments, the first cathode frame 806A does not contact the minor surfaces of the first cathode or the minor surface of the first bonding layer. Additionally, the second cathode frame 806B is adjacent to the minor surfaces of second cathode 805B, and/or the minor surfaces of the second bonding layer 808B. In some embodiments, the second cathode frame 806B does not contact the minor surfaces of the second cathode. In some embodiments, the second cathode frame 806B does not contact the minor surfaces of the second bonding layer. In some embodiments, the second cathode frame 806B does not contact the minor surfaces of the second cathode or the minor surfaces of the second bonding layer. In some embodiments, the first cathode frame 806A, is a solid, rectangular frame. In some embodiments, the second cathode frame 806B, is a solid, rectangular frame.

Additionally, bilayer stack 800 may include a first negative electrode seal 802A and a second negative electrode seal 802B. The first negative electrode seal is disposed between, and in contact with the first metal layer 803A and the first NECC 801A. Furthermore, the second negative electrode seal is disposed between, and in contact with the second metal layer 803B and the second NECC 801B.

In some embodiments, bilayer stack 800 may further include lithium metal disposed between, and in various embodiments, in contact with first metal layer 803A and first solid-state electrolyte 804A. In further embodiments, bilayer stack 800 may include lithium metal disposed between, and in various embodiments, in contact with second metal layer 803B and first solid-state electrolyte 804B.

In various embodiments, first solid-state electrolyte 804A and/or second solid-state electrolyte 804B may each include lithium-stuffed garnet. Additionally or alternatively, first solid-state electrolyte 804A and/or second solid-state electrolyte 804B may each be a film. In some embodiments, first solid-state electrolyte 804A and/or second solid-state electrolyte 804B may have a thickness of, for example, less than 100 μm. Furthermore, first solid-state electrolyte 804A may have a thickness in the range of 1 μm-100 μm, and/or second solid-state electrolyte 804B may have a thickness in the range of 1 μm-100 μm. For example, the thickness of first solid-state electrolyte 804A and/or second solid-state electrolyte 804B ranges from 1 μm-20 μm, 10 μm-20 μm, 20 μm-50 μm, 30 μm-60 μm, 25 μm-75 μm, 20 μm-80 μm, or 15 μm-30 μm.

In an aspect, the present disclosure provides a bilayer stack comprising: a first negative electrode current collector (NECC); a first metal layer; a first solid-state electrolyte; a first cathode; a positive electrode current collector (PECC); a second cathode; a second solid-state electrolyte; a second metal layer; and a second NECC; wherein the first cathode and the second cathode are on opposite sides of, and in contact with, the PECC; wherein the first NECC is adjacent to the first metal layer; and wherein the second NECC is adjacent to the second metal layer.

In some embodiments, the bilayer stack further comprises a first negative electrode seal. In some embodiments, the bilayer stack further comprises a second negative electrode seal. In some embodiments, the bilayer stack further comprises a first negative electrode seal and a second negative electrode seal.

In another aspect, the present disclosure provides a bilayer stack comprising: a first negative electrode current collector (NECC); a first negative electrode seal; a first metal layer; a first solid-state electrolyte; a first cathode; a positive electrode current collector (PECC); a second cathode; a second solid-state electrolyte; a second metal layer; a second negative electrode seal; and a second NECC; wherein the first cathode and the second cathode are on opposite sides of, and in contact with, the PECC; wherein the first NECC is adjacent to the first metal layer; and wherein the second NECC is adjacent to the second metal layer.

In some embodiments, the first negative electrode seal is between the first NECC and the first metal layer. In some embodiments, the second negative electrode seal is between the second NECC and the second metal layer. In some embodiments, the first negative electrode seal is between the first NECC and the first metal layer and the second negative electrode seal is between the second NECC and the second metal layer.

In some embodiments, the first negative electrode seal contacts the first NECC and the first metal layer. In some embodiments, the second negative electrode seal contacts the second NECC and the second metal layer. In some embodiments, the first negative electrode seal contacts the first NECC and the first metal layer and the second negative electrode seal contacts the second NECC and the second metal layer.

In some embodiments, the first negative electrode seal is between, and in contact with, the first NECC and the first metal layer. In some embodiments, the second negative electrode seal is between, and in contact with, the second NECC and the second metal layer. In some embodiments, the first negative electrode seal is between, and in contact with, the first NECC and the first metal layer and the second negative electrode seal is between, and in contact with, the second NECC and the second metal layer.

In some embodiments, the first solid-state electrolyte is between the first metal layer and the first cathode. In some embodiments, the second solid-state electrolyte is between the second metal layer and the second cathode. In some embodiments, the first solid-state electrolyte is between the first metal layer and the first cathode, and the second solid-state electrolyte is between the second metal layer and the second cathode.

In some embodiments, the first solid-state electrolyte contacts the first cathode and optionally contacts the first metal layer. In some embodiments, the second solid-state electrolyte contacts the second cathode and optionally contacts the second metal layer. In some embodiments, the first solid-state electrolyte contacts the first cathode and optionally contacts the first metal layer, and the second solid-state electrolyte contacts the second cathode and optionally contacts the second metal layer.

In some embodiments, the first solid-state electrolyte is between the first cathode and the first metal layer and contacts the first cathode and optionally contacts the first metal layer. In some embodiments, the second solid-state electrolyte is between the second cathode and the second metal layer and contacts the second cathode and optionally contacts the second metal layer. In some embodiments, the first solid-state electrolyte is between the first cathode and the first metal layer and contacts the first cathode and optionally contacts the first metal layer, and the second solid-state electrolyte is between the second cathode and the second metal layer and contacts the second cathode and optionally contacts the second metal layer.

In some embodiments, the bilayer stack further comprises a first lithium metal layer between the first metal layer and the first solid-state electrolyte. In some embodiments, the bilayer stack further comprises a second lithium metal layer between the second metal layer and the second solid-state electrolyte. In some embodiments, the bilayer stack further comprises a first lithium metal layer between the first metal layer and the first solid-state electrolyte and a second lithium metal layer between the second metal layer and the second solid-state electrolyte.

In some embodiments, the first lithium metal layer contacts the first metal layer and the first solid-state electrolyte. In some embodiments, the second lithium metal layer contacts the second metal layer and the second solid-state electrolyte. In some embodiments, the first lithium metal layer contacts the first metal layer and the first solid-state electrolyte and the second lithium metal layer contacts the second metal layer and the second solid-state electrolyte.

In some embodiments, the bilayer stack further comprises a first lithium metal layer between, and in contact with, the first metal layer and the first solid-state electrolyte. In some embodiments, the bilayer stack further comprises a second lithium metal layer between, and in contact with, the second metal layer and the second solid-state electrolyte. In some embodiments, the bilayer stack further comprises a first lithium metal layer between, and in contact with, the first metal layer and the first solid-state electrolyte and a second lithium metal layer between, and in contact with, the second metal layer and the second solid-state electrolyte.

In some embodiments, the first cathode and the second cathode contact the PECC.

In some embodiments, the bilayer stack further comprises a first cathode seal. In some embodiments, the bilayer stack further comprises a second cathode seal. In some embodiments, the bilayer stack comprises a first cathode seal and a second cathode seal. In some embodiments, the first cathode seal, the second cathode seal, or both, are ring seals. In some embodiments, the first cathode seal, the second cathode seal, or both, individually comprise one ring seal. In some embodiments, the first cathode seal, the second cathode seal, or both, individually comprise two ring seals. In some embodiments, the first cathode seal is a ring seal and is located in proximity to the perimeter of the first solid-state electrolyte. In some embodiments, the second cathode seal is a ring seal and is located in proximity to the perimeter of the first solid-state electrolyte.

In some embodiments, the first cathode seal is between the first solid-state electrolyte and the PECC. In some embodiments, the second cathode seal is between the second solid-state electrolyte and the PECC. In some embodiments, the first cathode seal is between the first solid-state electrolyte and the PECC, and the second cathode seal is between the second solid-state electrolyte and the PECC.

In some embodiments, the first cathode seal contacts the first solid-state electrolyte and the PECC. In some embodiments, the second cathode seal contacts the second solid-state electrolyte and the PECC. In some embodiments, the first cathode seal contacts the first solid-state electrolyte and the PECC, and the second cathode seal contacts the second solid-state electrolyte and the PECC.

In some embodiments, the first solid-state electrolyte and the second solid-state electrolyte each, individually in each instance, comprise lithium-stuffed garnet.

In some embodiments, including any of the foregoing, the first solid-state electrolyte and the second solid-state electrolyte are each, individually in each instance, a film.

In some embodiments, including any of the foregoing, the first solid-state electrolyte has a thickness less than 100 μm; and wherein the second solid-state electrolyte has a thickness less than 100 μm. In some embodiments, the first solid-state electrolyte has a thickness in the range of 1-100 μm, and the second solid-state electrolyte has a thickness in the range of 1-100 μm. In some embodiments, the thickness of the first and/or second solid-state electrolyte is least 10 nm, 50 nm, 5 μm, 10 μm, 15 μm, 20 μm, and 25 μm, or at least ranges from 1 μm-20 μm, 10-20 μm, 20 μm-50 μm, 30 μm-60 μm, 25 μm-75 μm, 20 μm-80 μm, or 15 μm-30 μm

In some embodiments, the first metal layer, the second metal layer, or both individually comprise nickel (Ni), iron (Fe), copper (Cu), platinum (Pt), gold (Au), silver (Ag), an alloy thereof, or a combination thereof. In some embodiments, the first metal layer, the second metal layer, or both individually do not comprise any lithium.

In some embodiments, the first metal layer, the second metal layer, or both, have an individual thickness of at least 10 nm, 50 nm, 500 nm, 1 μm, 2 μm, 3 μm, 4 μm, 5 μm, 6 μm, 7 μm, 8 μm, 9 μm or 10 μm. In some embodiments, the first metal layer, the second metal layer, or both, have an individual thickness of at most 200 μm, 100 μm, 75 μm, 50 μm, 25 μm or 15 μm. In some embodiments, the first metal layer, the second metal layer, or both, have an individual thickness of about 1 μm-20 μm, 1 μm-15 μm, 5 μm-20 μm, 5 μm-15 μm, 5 μm-10 μm, 1 μm-10 μm, 7 μm-13 μm, 8 μm-12 μm, or 9 μm-11 μm.

In some embodiments, the first negative electrode seal, the second negative electrode seal, or both individually have a thickness of about 1-20 μm, 1-15 μm, 1-10 μm, 2-10 μm, 2-8 μm, 4-8 μm, or 4-6 μm.

In some embodiments, the first NECC, the second NECC, or both, have an individual thickness of at least 10 nm, 50 nm, 500 nm, 1 μm, 2 μm, 3 μm, 4 μm, 5 μm, 6 μm, 7 μm, 8 μm, 9 μm or 10 μm. In some embodiments, the first NECC, the second NECC, or both, have an individual thickness of at most 500 μm, 250 μm, 200 μm, 100 μm, 75 μm, 50 μm, 25 μm, or 20 μm. In some embodiments, the first NECC, the second NECC, or both, have an individual thickness of about 1 μm-20 μm, 1 μm-15 μm, 5 μm-20 μm, 5 μm-15 μm, 5 μm-10 μm, 1 μm-10 μm, 2 μm-10 μm, 2 μm-8 μm or 4 μm-8 μm.

In some embodiments, the cathode current collector has a thickness of at least 10 nm, 50 nm, 500 nm, 1 μm, 5 μm, 10 μm, 15 μm, 20 μm, 25 μm, or 30 μm. In some embodiments, the cathode current collector has a thickness of at most 500 μm, 250 μm, 100, μm, 75 μm, or 50 μm. In some embodiments, the cathode current collector has a thickness of about 1 μm-50 μm, 5 μm-45 μm, 10 μm-40 μm, 20 μm-40 μm, 25 μm-35 μm, 5 μm-30 μm, 5 μm-25 μm, 5 μm-20 μm, or 5 μm-15 μm.

In some embodiments, the first cathode, the second cathode, or both individually have a thickness of about 50-150 μm, 50-130 μm, 70-130 μm, 80-125 μm, 90-120 μm, 95-120 μm, 90-110 μm, or 90-100 μm.

In some embodiments, the first cathode seal, the second cathode seal, or both, individually have a thickness of about 50-300 μm, 50-250 μm, 50-200 μm, 100-200 μm, 120-200 μm, 120-180 μm, 140-180 μm, or 140-160 μm.

In some embodiments, the first cathode and the second cathode each comprise a catholyte. In some embodiments, the catholyte is a liquid catholyte. In some embodiments, the catholyte comprises ethylene sulfite, sulfolane, or combinations thereof.

In some embodiments, including any of the foregoing, set forth herein is a battery stack comprising two or more bilayer stacks described herein.

In another aspect, the present disclosure provides a bilayer stack comprising: a first negative electrode current collector (NECC); a first negative electrode seal; a first metal layer; a first solid-state electrolyte; a first bonding layer; a first cathode; a positive electrode current collector (PECC); a second cathode; a second bonding layer; a second solid-state electrolyte; a second metal layer; a second negative electrode seal; and a second NECC; wherein the first cathode and the second cathode are on opposite sides of, and in contact with, the PECC; wherein the first NECC is adjacent to the first metal layer; and wherein the second NECC is adjacent to the second metal layer.

In some embodiments, the bilayer stack further comprises a first buffer layer between the first bonding layer and the first cathode. In some embodiments, the bilayer stack further comprises a second buffer layer between the second bonding layer and the second cathode. In some embodiments, the bilayer stack further comprises a first buffer layer between the first bonding layer and the first cathode, and a second buffer layer between the second bonding layer and the second cathode.

In some embodiments, the first buffer layer contacts the first bonding layer and the first cathode. In some embodiments, the second buffer layer contacts the second bonding layer and the second cathode. In some embodiments, the first buffer layer contacts the first bonding layer and the first cathode, and the second buffer layer contacts the second bonding layer and the second cathode.

In some embodiments, the first buffer layer is between, and in contact with, the first bonding layer and the first cathode. In some embodiments, the second buffer layer is between, and in contact with, the second bonding layer and the second cathode. In some embodiments, the first buffer layer is between, and in contact with, the first bonding layer and the first cathode, and the second buffer layer is between, and in contact with, the second bonding layer and the second cathode.

In some embodiments, the first bonding layer is between the first solid-state electrolyte and the first cathode. In some embodiments, the second bonding layer is between the second solid-state electrolyte and the second cathode. In some embodiments, the first bonding layer is between the first solid-state electrolyte and the first cathode, and the second bonding layer is between the second solid-state electrolyte and the second cathode.

In some embodiments, the first bonding layer contacts the first solid-state electrolyte and optionally contacts the first cathode. In some embodiments, the second bonding layer contacts the second solid-state electrolyte and optionally contacts the second cathode. In some embodiments, the first bonding layer contacts the first solid-state electrolyte and optionally contacts the first cathode, and the second bonding layer contacts the second solid-state electrolyte and optionally contacts the second cathode.

In some embodiments, the first bonding layer is between the first solid-state electrolyte and the first cathode and contacts the first solid-state electrolyte and optionally contacts the first cathode. In some embodiments, the second bonding layer is between the second solid-state electrolyte and the second cathode and contacts the second solid-state electrolyte and optionally contacts the second cathode. In some embodiments, the first bonding layer is between the first solid-state electrolyte and the first cathode and contacts the first solid-state electrolyte and optionally contacts the first cathode, and the second bonding layer is between the second solid-state electrolyte and the second cathode and contacts the second solid-state electrolyte and optionally contacts the second cathode.

In another aspect, the present disclosure provides a bilayer stack comprising: a first negative electrode current collector (NECC); a first negative electrode seal; a first metal layer; a first solid-state electrolyte; a first bonding layer; a first buffer layer; a first cathode; a positive electrode current collector (PECC); a second cathode; a second buffer layer; a second bonding layer; a second solid-state electrolyte; a second metal layer; a second negative electrode seal; and a second NECC; wherein the first cathode and the second cathode are on opposite sides of, and in contact with, the PECC; wherein the first NECC is adjacent to the first metal layer; and wherein the second NECC is adjacent to the second metal layer.

In some embodiments, the first buffer layer is between the first bonding layer and the first cathode. In some embodiments, the second buffer layer is between the second bonding layer and the second cathode. In some embodiments, the first buffer layer is between the first bonding layer and the first cathode, and the second buffer layer is between the second bonding layer and the second cathode.

In some embodiments, the first buffer layer contacts the first bonding layer and the first cathode. In some embodiments, the second buffer layer contacts the second bonding layer and the second cathode. In some embodiments, the first buffer layer contacts the first bonding layer and the first cathode, and the second buffer layer contacts the second bonding layer and the second cathode.

In some embodiments, the first buffer layer is between, and in contact with, the first bonding layer and the first cathode. In some embodiments, the second buffer layer is between, and in contact with, the second bonding layer and the second cathode. In some embodiments, the first buffer layer is between, and in contact with, the first bonding layer and the first cathode, and the second buffer layer is between, and in contact with, the second bonding layer and the second cathode.

In some embodiments, the first bonding layer is between the first solid-state electrolyte and the first buffer layer. In some embodiments, the second bonding layer is between the second solid-state electrolyte and the second buffer layer. In some embodiments, the first bonding layer is between the first solid-state electrolyte and the first buffer layer, and the second bonding layer is between the second solid-state electrolyte and the second buffer layer.

In some embodiments, the first bonding layer contacts the first solid-state electrolyte and the first buffer layer. In some embodiments, the second bonding layer contacts the second solid-state electrolyte and the second buffer layer. In some embodiments, the first bonding layer contacts the first solid-state electrolyte and the first buffer layer, and the second bonding layer contacts the second solid-state electrolyte and the second buffer layer.

In some embodiments, the first bonding layer is between the first solid-state electrolyte and the first cathode and contacts the first solid-state electrolyte and optionally contacts the first cathode. In some embodiments, the second bonding layer is between the second solid-state electrolyte and the second cathode and contacts the second solid-state electrolyte and optionally contacts the second cathode. In some embodiments, the first bonding layer is between the first solid-state electrolyte and the first cathode and contacts the first solid-state electrolyte and optionally contacts the first cathode, and the second bonding layer is between the second solid-state electrolyte and the second cathode and contacts the second solid-state electrolyte and optionally contacts the second cathode.

In some embodiments, the first negative electrode seal is between the first NECC and the first metal layer. In some embodiments, the second negative electrode seal is between the second NECC and the second metal layer. In some embodiments, the first negative electrode seal is between the first NECC and the first metal layer and the second negative electrode seal is between the second NECC and the second metal layer.

In some embodiments, the first negative electrode seal contacts the first NECC and the first metal layer. In some embodiments, the second negative electrode seal contacts the second NECC and the second metal layer. In some embodiments, the first negative electrode seal contacts the first NECC and the first metal layer and the second negative electrode seal contacts the second NECC and the second metal layer.

In some embodiments, the first negative electrode seal is between, and in contact with, the first NECC and the first metal layer. In some embodiments, the second negative electrode seal is between, and in contact with, the second NECC and the second metal layer. In some embodiments, the first negative electrode seal is between, and in contact with, the first NECC and the first metal layer and the second negative electrode seal is between, and in contact with, the second NECC and the second metal layer.

In some embodiments, the first solid-state electrolyte is between the first metal layer and the first bonding layer. In some embodiments, the second solid-state electrolyte is between the second metal layer and the second bonding layer. In some embodiments, the first solid-state electrolyte is between the first metal layer and the first bonding layer, and the second solid-state electrolyte is between the second metal layer and the second bonding layer.

In some embodiments, the first solid-state electrolyte contacts the first bonding layer and optionally contacts the first metal layer. In some embodiments, the second solid-state electrolyte contacts the second bonding layer and optionally contacts the second metal layer. In some embodiments, the first solid-state electrolyte contacts the first bonding layer and optionally contacts the first metal layer, and the second solid-state electrolyte contacts the second bonding layer and optionally contacts the second metal layer.

In some embodiments, the first solid-state electrolyte is between the first bonding layer and the first metal layer and contacts the first bonding layer and optionally contacts the first metal layer. In some embodiments, the second solid-state electrolyte is between the first bonding layer and the first metal layer and contacts the second bonding layer and optionally contacts the second metal layer. In some embodiments, the first solid-state electrolyte is between the first bonding layer and the first metal layer and contacts the first bonding layer and optionally contacts the first metal layer, and the second solid-state electrolyte is between the first bonding layer and the first metal layer and contacts the second bonding layer and optionally contacts the second metal layer.

In some embodiments, the bilayer stack further comprises a first lithium metal layer between the first metal layer and the first solid-state electrolyte. In some embodiments, the bilayer stack further comprises a second lithium metal layer between the second metal layer and the second solid-state electrolyte. In some embodiments, the bilayer stack further comprises a first lithium metal layer between the first metal layer and the first solid-state electrolyte and a second lithium metal layer between the second metal layer and the second solid-state electrolyte.

In some embodiments, the first lithium metal layer contacts the first metal layer and the first solid-state electrolyte. In some embodiments, the second lithium metal layer contacts the second metal layer and the second solid-state electrolyte. In some embodiments, the first lithium metal layer contacts the first metal layer and the first solid-state electrolyte and the second lithium metal layer contacts the second metal layer and the second solid-state electrolyte.

In some embodiments, the bilayer stack further comprises a first lithium metal layer between, and in contact with, the first metal layer and the first solid-state electrolyte. In some embodiments, the bilayer stack further comprises a second lithium metal layer between, and in contact with, the second metal layer and the second solid-state electrolyte. In some embodiments, the bilayer stack further comprises a first lithium metal layer between, and in contact with, the first metal layer and the first solid-state electrolyte and a second lithium metal layer between, and in contact with, the second metal layer and the second solid-state electrolyte.

In some embodiments, the first cathode and the second cathode contact the PECC.

In some embodiments, the bilayer stack further comprises a first cathode frame. In some embodiments, the bilayer stack further comprises a second cathode frame. In some embodiments, the bilayer stack comprises a first cathode frame and a second cathode frame. In some embodiments, the first cathode frame is a solid, rectangular frame. In some embodiments, the second cathode frame is a solid, rectangular frame.

In some embodiments, the first cathode frame is between the first solid-state electrolyte and the PECC. In some embodiments, the second cathode frame is between the second solid-state electrolyte and the PECC. In some embodiments, the first cathode frame is between the first solid-state electrolyte and the PECC, and the second cathode frame is between the second solid-state electrolyte and the PECC.

In some embodiments, the first cathode frame contacts the first solid-state electrolyte and the PECC. In some embodiments, the second cathode frame contacts the second solid-state electrolyte and the PECC. In some embodiments, the first cathode frame contacts the first solid-state electrolyte and the PECC, and the second cathode frame contacts the second solid-state electrolyte and the PECC.

In some embodiments, the first solid-state electrolyte and the second solid-state electrolyte each, individually in each instance, comprise lithium-stuffed garnet.

In some embodiments, including any of the foregoing, the first solid-state electrolyte and the second solid-state electrolyte are each, individually in each instance, a film.

In some embodiments, including any of the foregoing, the first solid-state electrolyte has a thickness less than 100 μm; and wherein the second solid-state electrolyte has a thickness less than 100 μm. In some embodiments, the first solid-state electrolyte has a thickness in the range of 1-100 μm, and the second solid-state electrolyte has a thickness in the range of 1-100 μm. In some embodiments, the thickness of the first and/or second solid-state electrolyte is least 10 nm, 50 nm, 5 μm, 10 μm, 15 μm, 20 μm, and 25 μm, or at least ranges from 1 μm-20 μm, 10 μm-20 μm, 20 μm-50 μm, 30 μm-60 μm, 25 μm-75 μm, 20 μm-80 μm, or 15 μm-30 μm

In some embodiments, the first metal layer, the second metal layer, or both individually comprise nickel (Ni), iron (Fe), copper (Cu), platinum (Pt), gold (Au), silver (Ag), an alloy thereof, or a combination thereof. In some embodiments, the first metal layer, the second metal layer, or both individually do not comprise any lithium.

In some embodiments, the first metal layer, the second metal layer, or both, have an individual thickness of at least 10 nm, 50 nm, 500 nm, 1 μm, 2 μm, 3 μm, 4 μm, 5 μm, 6 μm, 7 μm, 8 μm, 9 μm or 10 μm. In some embodiments, the first metal layer, the second metal layer, or both, have an individual thickness of at most 200 μm, 100 μm, 75 μm, 50 μm, 25 μm or 20 μm. In some embodiments, the first metal layer, the second metal layer, or both, have an individual thickness of about 1 μm-20 μm, 1 μm-15 μm, 5 μm-20 μm, 5 μm-15 μm, 5 μm-10 μm, 1 μm-10 μm, 7 μm-13 μm, 8 μm-12 μm, or 9 μm-11 μm.

In some embodiments, the first negative electrode seal, the second negative electrode seal, or both individually have a thickness of about 1 μm-20 μm, 1 μm-15 μm, 1 μm
10 μm, 2 μm-10 μm, 2 μm-8 μm, 4 μm-8 μm, or 4 μm-6 μm.

In some embodiments, the first NECC, the second NECC, or both, have an individual thickness of at least 10 nm, 50 nm, 500 nm, 1 μm, 2 μm, 3 μm, 4 μm, 5 μm, 6 μm, 7 μm, 8 μm, 9 μm or 10 μm. In some embodiments, the first NECC, the second NECC, or both, have an individual thickness of at most 500 μm, 250 μm, 200 μm, 100 μm, 75 μm, 50 μm, 25 μm, or 20 μm. In some embodiments, the first NECC, the second NECC, or both, have an individual thickness of about 1 μm-20 μm, 1 μm-15 μm, 5 μm-20 μm, 5 μm-15 μm, 5 μm-10 μm, 1 μm-10 μm, 2 μm-10 μm, 2 μm-8 μm or 4 μm-8 μm.

In some embodiments, the cathode current collector has a thickness of at least 10 nm, 50 nm, 500 nm, 1 μm, 5 μm, 10 μm, 15 μm, 20 μm, 25 μm, or 30 μm. In some embodiments, the cathode current collector has a thickness of at most 500 μm, 250 μm, 100, μm, 75 μm, or 50 μm. In some embodiments, the cathode current collector has a thickness of about 1 μm-50 μm, 5 μm-45 μm, 10 μm-40 μm, 20 μm-40 μm, or 25 μm-35 μm.

In some embodiments, the first cathode, the second cathode, or both individually have a thickness of about 50-150 μm, 50-130 μm, 70-130 μm, 80-125 μm, 90-120 μm, or 95-120 μm.

In some embodiments, the first cathode frame, the second cathode frame, or both, individually have a thickness of about 50-200 μm, 50-150 μm, 70-150 μm, 80-140 μm, 90-130 μm, or 100-130 μm.

In some embodiments, the first bonding layer, the second bonding layer, or both individually, have a thickness of at least 10 nm, 50 nm, 500 nm, 1 μm, 2 μm, 3 μm, 4 μm, 5 μm, 6 μm, 7 μm, 8 μm, 9 μm or 10 μm. In some embodiments, the first bonding layer, the second bonding layer, or both individually, have a thickness of at most 200 μm, 100 μm, 75 μm, 50 μm, 25 μm, or 15 μm. In some embodiments, the first bonding layer, the second bonding layer, or both individually, have a thickness of 1 μm-15 μm, 5 μm-15 μm, 5 μm-14 μm, 5 μm-13 μm, 7 μm-13 μm, 1 μm-10 μm, 1 μm-8 μm, 1 μm-6 μm, 2 μm-6 μm.

In some embodiments, the first buffer layer, the second buffer layer, or both individually, have a thickness of at least 10 nm, 50 nm, 500 nm, 1 μm, 2 μm, 3 μm, 4 μm, 5 μm, 6 μm, 7 μm, 8 μm, 9 μm or 10 μm. In some embodiments, the first buffer layer, the second buffer layer, or both individually, have a thickness of at most 200 μm, 100 μm, 75 μm, 50 μm, 25 μm, or 15 μm. In some embodiments, the first buffer layer, the second buffer layer, or both individually, have a thickness of 1 μm-15 μm, 5 μm-15 μm, 5 μm-14 μm, 5 μm-13 μm, 7 μm-13 μm, 1 μm-10 μm, 1 μm-8 μm, 1 μm-6 μm, 2 μm-6 μm.

In some embodiments, the first cathode and the second cathode each comprise a catholyte. In some embodiments, the catholyte is a solid catholyte.

In some embodiments, including any of the foregoing, set forth herein is a battery stack comprising two or more bilayer stacks described herein.

In another aspect, the present disclosure provides a bilayer stack comprising: a positive electrode current collector (PECC); a negative electrode current collector (NECC); a first cathode and a second cathode on opposite sides of, and in contact with, the PECC; a first solid-state electrolyte between the NECC and the first cathode; and a second solid-state electrolyte adjacent to the second cathode. In some embodiments, including any of the foregoing, the first solid-state electrolyte and the second solid-state electrolyte each, individually in each instance, comprise lithium-stuffed garnet.

In some embodiments, including any of the foregoing, the first solid-state electrolyte and the second solid-state electrolyte are each, individually in each instance, a film.

In some embodiments, including any of the foregoing, the first solid-state electrolyte has a thickness less than 100 μm; and wherein the second solid-state electrolyte has a thickness less than 100 μm.

In some embodiments, including any of the foregoing, the stack further comprises a second NECC adjacent to the second solid-state electrolyte.

In some embodiments, including any of the foregoing, the stack further comprises lithium metal between the first solid-state electrolyte and the NECC.

In some embodiments, including any of the foregoing, the stack further comprises lithium metal on two sides of the NECC.

In some embodiments, including any of the foregoing, wherein the first cathode and the second cathode each, individually in each instance, comprise a cathode seal.

In some embodiments, including any of the foregoing, the stack further comprises a seal between the NECC and the first solid-state electrolyte.

In some embodiments, including any of the foregoing, set forth herein is a multilayer stack comprising two or more bilayer stacks described herein.

In one embodiment, set forth herein is a multilayer stack comprising: a negative electrode current collector (NECC); a first cathode and a second cathode; a first positive electrode current collector (first PECC) and a second positive electrode current collector (second PECC); a first solid-state electrolyte and a second solid-state electrolyte on opposite sides of the NECC; wherein the first cathode is between the first solid-state electrolyte and the first PECC; and wherein the second cathode is between the second solid-state electrolyte and the second PECC.

In some embodiments, including any of the foregoing, the first solid-state electrolyte and the second solid-state electrolyte comprise lithium-stuffed garnet.

In some embodiments, including any of the foregoing, the first solid-state electrolyte and the second solid-state electrolyte are each, individually in each instance, a film.

In some embodiments, including any of the foregoing, the first solid-state electrolyte has a thickness less than 100 μm; and wherein the second solid-state electrolyte has a thickness less than 100 μm.

In some embodiments, including any of the foregoing, wherein the stack includes lithium metal on two sides of the NECC.

In some embodiments, including any of the foregoing, wherein lithium metal is between and in contact with the first solid-state electrolyte and the NECC.

In some embodiments, including any of the foregoing, wherein lithium metal is between and in contact with the second solid-state electrolyte and the NECC.

In some embodiments, including any of the foregoing, wherein the first cathode and the second cathode each, individually in each instance, comprise a cathode seal.

In some embodiments, including any of the foregoing, the stack further comprises a third cathode on the side of the first PECC opposite the first cathode.

In some embodiments, including any of the foregoing, the stack further comprises a fourth cathode on the side of the second PECC opposite the second cathode.

In some embodiments, including any of the foregoing, the stack further comprises a seal between the NECC and the first solid-state electrolyte; and further comprising a seal between the NECC and the second solid-state electrolyte.

In some embodiments, including any of the foregoing, the first solid-state electrolyte has a thickness less than 100 μm; and wherein the second solid-state electrolyte has a thickness less than 100 μm.

In some embodiments, including any of the foregoing, set forth herein is a stack comprising two or more bilayer stacks described herein.

### EXAMPLES

Reagents, chemicals, and materials disclosed herein were commercially purchased unless stated otherwise.

Unless specified otherwise, lithium-stuffed garnet films (i.e., solid-state electrolytes) were prepared as follows. A slurry of lithium-stuffed garnet precursor materials were deposited by the doctor-blade method on aluminum-based setters and sintered at 1000° C. to 1300° C. to prepare thin films of lithium-stuffed garnet that were about 20 microns to 50 microns (μm) in thickness.

Unless specified otherwise, bilayers (film on metal foil) were prepared as follows. A slurry of lithium-stuffed garnet precursor materials was cast onto a metal foil and dried to form a green tape. The bilayer was sintered at 1000° C. to 1300° C. The sintered films were then cut to the appropriate dimensions using a laser cutter.

The lithium-stuffed garnet layer was made according to the methods of forming a layer or film of the lithium-stuffed garnet in U.S. Pat. No. 9,806,372 B2, which issued Oct. 31, 2017, and is titled GARNET materials FOR LI SECONDARY BATTERIES AND METHODS OF MAKING and USING GARNET MATERIALS, and 9,970,711, which issued May 15, 2018, and is titled LITHIUM STUFFED GARNET SETTER PLATES FOR SOLID ELECTROLYTE FABRICATION, the entire contents of which are herein incorporated by reference in their entirety for all purposes.

### Example 1: Method 1—Battery Bi-Layer Stack Assembly

A cathode electrode was prepared by mixing 2% Super C65, 2% Kynar® HSV, and 96% by weight of NMC in NMP (n-methyl pyrrolidone). After mixing and degassing, the slurry was cast onto an aluminum foil with a doctor blade to a thickness that achieves 28 mg/cm² of dry material. The electrode was dried of NMP at 120° C. for eight hours to yield a first cathode layer (i.e., first cathode). After drying the first cathode, the slurry was cast and dried on the other side of the aluminum foil as above to yield a second cathode layer (i.e., second cathode). Cathode electrodes of approximately 55 mm×70 mm were cut from the cathode electrode sheet by means of laser notching. Finally, the electrode was calendered to a thickness where the porosity was 25% or 35% by volume.

Battery stacks were constructed using film on foil bilayers comprising a lithium-stuffed garnet solid-state layer and a metal layer, lithium-free lithium metal anodes, anode seals, and the cathode electrode described above. Lithium-free means the battery stacks were assembled in a discharged state.

Before stack assembly, the cathode electrode was soaked in a catholyte mixture of ESS (85:15 v/v % ethylene sulfite:sulfolane+1.7M LiBF₄:LiTFSI (80:20)). After soaking, excess electrolyte was removed by dabbing.

An anode seal was applied to the major surface of a first anode current collector foil with a tab. The anode seal was placed in contact with the anode side of a first solid-state electrolyte, wherein the anode seal contacts the metal layer of the solid-state electrolyte. Next, a cathode seal was applied on the exposed surface of the solid-state electrolyte (i.e., on the lithium-stuffed garnet) as a ring in proximity to the perimeter of the cathode.

The assembly from above was placed on top of one of the cathode layers of the cathode electrode, so that the lithium-stuffed garnet layer contacts the first cathode layer, and that the cathode seal sits adjacent to the first cathode layer. Similarly, a second solid-state electrolyte with a second cathode seal ring, a second anode seal, and a second anode current collector was placed on top of the second cathode layer, thereby forming a bilayer stack.

### Example 2: Method 2—Battery Bi-Layer Stack Assembly

Battery stacks were constructed using film on foil bilayers comprising a lithium-stuffed garnet solid-state layer and a metal layer, lithium-free lithium metal anodes, and the layers described below. Lithium-free means the battery stacks were assembled in a discharged state.

A first and second positive electrode (i.e., cathodes) was prepared. A slurry was prepared with 30-80 weight % solid loading in 20-70% toluene. The solid loading comprised 70-95 wt % lithium-zirconium-oxide (LZO)-coated lithiated nickel-cobalt-aluminum oxide active material (NCA), 13 wt % LSTPS and 2 wt % binder. The LSTPS composition was characterized as LiₐSi_{b}Sn_{c}P_{d}Sₑ, wherein a is 5, b is 0.75, c is 0.25, d is 1, and e is 6, and further it comprised an oxygen element from greater than 0 to 15 atomic %, and was prepared as described in U.S. Pat. No. 9,172,114, which issued Oct. 27, 2015, and is titled SOLID STATE CATHOLYTES AND ELECTROLYTES FOR ENERGY STORAGE DEVICES, the entire contents of which are herein incorporated by reference in their entirety for all purposes.

The slurry was cast using a doctor blade on carbon-coated aluminum foil. The resulting cast slurry was dried at room temperature to 120° C. for 1-24 hours to form a first positive electrode layer film on the carbon coated Al foil (i.e., first cathode). After drying the first cathode, the slurry was cast and dried on the other side of the aluminum foil as above to yield a second cathode.

A first and second sulfide buffer layer was prepared. A slurry was prepared with 10-70 wt % LSTPS in toluene. The slurry was cast using a doctor blade casting method on Ni foil. The resulting cast slurry was dried at room temperature to 120° C. for 1-24 hours to form a buffer layer film (i.e., first buffer layer). A second buffer layer was prepared similarly to the first buffer layer. In this example, the buffer layer included the same chemical composition LSTPS as was used in the positive electrode layer. Without being bound to theory, it was proposed that this layer was not conductive to electrons (had an electron conductivity less than 1E-6 S/cm). This buffer layer thereby shielded the negative electrode (anode) potential from the positive electrode layers.

The buffer layers were placed on top of the cathode layers so that the first buffer layer and the first cathode layer, and separately, the second buffer layer and the second cathode layer, are in direct contact with each other to produce a subassembly (Nickel film-buffer layer-positive electrode layer-aluminum film).

The subassembly from above is placed on an aluminum guide foil. The assembly is then passed through a calender at 1.0 meters/min, 140° C., and ~100-110 bar (10-11 MPa) hydraulic pressure (to apply 1100-1200 N/mm). Saueressig GK 300 L or Ono Roll Type 12 calenders were used. Once calendered, the subassembly layers were densified together in one step. A carbon-coated aluminum foil was also bonded to the aluminum guide foil during calendering and formed a first current collector on the side of the cathode.

A first and a second borohydride bonding layer was prepared. The borohydride composition used to form the borohydride bonding layer was described according to International PCT Patent Application Publication No. WO2018075972A1, filed Oct. 20, 2017, and entitled ELECTROLYTE SEPARATORS INCLUDING LITHIUM BOROHYDRIDE AND COMPOSITE ELECTROLYTE SEPARATORS OF LITHIUM-STUFFED GARNET

AND LITHIUM BOROHYDRIDE; also International PCT Patent Application Publication No. WO2019078897A1, filed Oct. 20, 2017, and entitled BOROHYDRIDE-SULFIDE INTERFACIAL LAYER IN ALL SOLID-STATE BATTERY, the entire contents of which are herein incorporated by reference in their entirety for all purposes. The composition, 3LiBH₄·2LiCl·3LiNH₂, was separately melted and spin-coated on top of the first and second buffer layer from the subassembly above to form an assembly.

A PTFE liner was placed on a stainless-steel substrate to prevent static and attachment of any electrochemical stack components during assembly. Next, a first cathode frame was placed on the PTFE liner. The assembly from above was placed within the frame and centered with respect to the frame center and the first cathode, so that the first frame surrounds the perimeter of the first cathode. Next, a second frame identical to the first frame was placed and centered with respect to the frame center and the second cathode. The inner frame length, inner frame width, and overall frame thickness were larger than the respective length, width, and thickness of either of the cathodes. A second PTFE liner followed by a second stainless steel substrate was placed on top of the assembly. A high-temperature silicone foam was added on the top stainless-steel plate to provide uniform pressure distribution. The assembly was heated at a temperature of about 65° C. to 75° C. and at a pressure of about 70 kPa to 700 kPa for 2 minutes. The assembly was taken out and allowed to cool to room temperature.

A first anode seal was applied to the major surface of a first anode current collector foil with a tab, and a second anode seal was applied to the major surface of a second anode current collector foil with a tab. The first and second anode seal were respectively placed in contact with the anode side of a first and second solid-state electrolyte to form substacks, wherein the anode seal contacts the metal layer of the solid-state electrolyte.

The substacks from above were placed on top of the frame on both sides of the assembly from above to form a bilayer stack, so that the lithium-stuffed garnet layers contact the frames and the bonding layers. Finally, the bilayer stack was heated at a temperature of about 80° C. to 160° C. and at a pressure of about 70 kPa to 700 kPa for a few minutes. The bilayer stack was then cooled to room temperature.

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

What is claimed is:

1. A bilayer stack comprising:
a first negative electrode current collector (NECC);
a first metal layer;
a first solid-state electrolyte;
a first cathode;
a positive electrode current collector (PECC);
a second cathode;
a second solid-state electrolyte;
a second metal layer;
and a second NECC;
wherein the first cathode and the second cathode are on opposite sides of, and in contact with, the PECC;
wherein the first NECC is adjacent to the first metal layer; and
wherein the second NECC is adjacent to the second metal layer.

2. The bilayer stack of claim 1, further comprising a first lithium metal layer between, and in contact with, the first metal layer and the first solid-state electrolyte; and further comprising a second lithium metal layer between, and in contact with, the second metal layer and the second solid-state electrolyte.

3. The bilayer stack of any one of claims 1-2, further comprising a first negative electrode seal between, and in contact with, the first NECC and the first metal layer; and further comprising a second negative electrode seal between, and in contact with, the second NECC and the second metal layer.

4. The bilayer stack of any one of claims 1-3, wherein the first solid-state electrolyte is between the first metal layer and the first cathode, and wherein the second solid-state electrolyte is between the second metal layer and the second cathode, wherein the first solid-state electrolyte contacts the first cathode and optionally contacts the first metal layer, and wherein the second solid-state electrolyte contacts the second cathode and optionally contacts the second metal layer.

5. The bilayer stack of any one of claims 1-4, wherein the first solid-state electrolyte and the second solid-state electrolyte each, individually in each instance, comprise lithium-stuffed garnet.

6. The bilayer stack of any one of claims 1-5, wherein the first solid-state electrolyte and the second solid-state electrolyte are each, individually in each instance, a film.

7. The bilayer stack of any one of claims 1-6, wherein the first solid-state electrolyte has a thickness less than 100 μm and greater than 10 nm; and wherein the second solid-state electrolyte has a thickness less than 100 μm and greater than 10 nm.

8. The bilayer stack of any one of claims 1-7, wherein the first metal layer, the second metal layer, or both comprise nickel (Ni), iron (Fe), copper (Cu), platinum (Pt), gold (Au), silver (Ag), an alloy thereof, or a combination thereof.

9. The bilayer stack of any one of claims 1-8, further wherein the bilayer stack comprises a first cathode seal and a second cathode seal.

10. The bilayer stack of any one of claims 1-9, wherein the first cathode and the second cathode each comprise a catholyte.

11. The bilayer stack of claim 10, wherein the catholyte is a liquid catholyte.

12. A stack comprising two or more bilayer stacks of any one of claims 1-11.

13. A bilayer stack comprising:
a first negative electrode current collector (NECC);
a first negative electrode seal;
a first metal layer;
a first solid-state electrolyte;
a first cathode;
a positive electrode current collector (PECC);
a second cathode;
a second solid-state electrolyte;
a second metal layer;
a second negative electrode seal;
and a second NECC;
wherein the first cathode and the second cathode are on opposite sides of, and in contact with, the PECC;
wherein the first NECC is adjacent to the first metal layer; and
wherein the second NECC is adjacent to the second metal layer.

14. A stack comprising two or more bilayer stacks of claim 13.

15. A bilayer stack comprising:
a first negative electrode current collector (NECC);
a first negative electrode seal;
a first metal layer;
a first solid-state electrolyte;
a first bonding layer;
a first cathode;
a positive electrode current collector (PECC);
a second cathode;
a second bonding layer;
a second solid-state electrolyte;
a second metal layer;
a second negative electrode seal;
and a second NECC;
wherein the first cathode and the second cathode are on opposite sides, and in contact with, of the PECC;
wherein the first NECC is adjacent to the first metal layer; and
wherein the second NECC is adjacent to the second metal layer.

16. The bilayer stack of claim 15, wherein the first bonding layer is between the first solid-state electrolyte and the first cathode, and wherein the second bonding layer is between the second solid-state electrolyte and the second cathode, wherein the first bonding layer contacts the first solid-state electrolyte and optionally contacts the first cathode, and the second bonding layer contacts the second solid-state electrolyte and optionally contacts the second cathode.

17. The bilayer stack of claim 15 or 16, further comprising a first buffer layer between, and in contact with, the first bonding layer and the first cathode; and further comprising a second buffer layer between, and in contact with, the second bonding layer and the second cathode.

18. The bilayer stack of any one of claims 15-17, further comprising a first lithium metal layer between, and in contact with, the first metal layer and the first solid-state electrolyte; and further comprising a second lithium metal layer between, and in contact with, the second metal layer and the second solid-state electrolyte.

19. The bilayer stack of any one of claims 15-18, wherein the first negative electrode seal is between, and in contact with, the first NECC and the first metal layer, and wherein the second negative electrode seal is between, and in contact with, the second NECC and the second metal layer

20. The bilayer stack of any one of claims 15-19, wherein the first solid-state electrolyte is between the first metal layer and the first bonding layer, and wherein the second solid-state electrolyte is between the second metal layer and the second bonding layer, wherein the first solid-state electrolyte contacts the first bonding layer and optionally contacts the first metal layer, and wherein the second solid-state electrolyte contacts the second bonding layer and optionally contacts the second metal layer.

21. The bilayer stack of any one of claims 15-20, wherein the first solid-state electrolyte and the second solid-state electrolyte each, individually in each instance, comprise lithium-stuffed garnet.

22. The bilayer stack of any one of claims 15-21, wherein the first solid-state electrolyte and the second solid-state electrolyte are each, individually in each instance, a film.

23. The bilayer stack of any one of claims 15-23, wherein the first solid-state electrolyte has a thickness less than 100 μm and greater than 10 nm; and wherein the second solid-state electrolyte has a thickness less than 100 μm and greater than 10 nm.

24. The bilayer stack of any one of claims 15-23, wherein the first metal layer, the second metal layer, or both comprise nickel (Ni), iron (Fe), copper (Cu), platinum (Pt), gold (Au), silver (Ag), an alloy thereof, or a combination thereof.

25. The bilayer stack of any one of claims 15-24, further wherein the bilayer stack comprises a first cathode frame and a second cathode frame.

26. The bilayer stack of any one of claims 15-25, wherein the first cathode and the second cathode each comprise a catholyte.

27. The bilayer stack of claim 26, wherein the catholyte is a solid catholyte.

28. A stack comprising two or more bilayer stacks of any one of claims 15-27.
